(19) United States
(12) Patent Application Publication
(10) Pub. No.: US 2020/0151333 A1
(43) Pub. Date: May 14, 2020

(54) IMAGE FORMING APPARATUS AND CONTROL PROGRAM FOR IMAGE FORMING APPARATUS

(71) Applicant: KONICA MINOLTA, INC., Tokyo (JP)

(72) Inventors: Kazuhiro TOMIYASU, Toyokawa-shi (JP); Kaoru FUKUOKA, Toyokawa-shi (JP); Hiroaki SUGIMOTO, Nagoya-shi (JP)

(73) Assignee: KONICA MINOLTA, INC., Tokyo (JP)

(21) Appl. No.: 16/668,648

(22) Filed: Oct. 30, 2019

(30) Foreign Application Priority Data
Nov. 14, 2018 (JP) 2018-213826

(51) Int. Cl. G06F 21/56; G06F 3/12; H04N 1/00

(52) U.S. Cl. CPC G06F 21/564; G06F 3/1222; G06F 3/1239; G06F 2221/034; H04N 1/00411; G06F 21/565; H04N 1/00477

(57) ABSTRACT

An image forming apparatus includes: a hardware processor that detects multiple files stored in the external storage when an external storage is installed to the image forming apparatus, determines a scan order of each of the multiple files detected by the hardware processor, and scans each of the multiple files for viruses in the scan order; and an acceptor that accepts a print instruction for a file stored in the external storage, wherein the hardware processor determines whether it is necessary to execute virus scanning on a print target file before printing depending on whether the hardware processor has completed virus scanning on the print target file, which is the file for which the print instruction has been accepted by the acceptor.

The entire disclosure of Japanese patent Application No. 2018-213826, filed on Nov. 14, 2018, is incorporated herein by reference in its entirety.

### BACKGROUND

### Technological Field

The present invention relates to an image forming apparatus and a control program for the image forming apparatus. More specifically, the present invention relates to an image forming apparatus and a control program for the image forming apparatus capable of suppressing delay in printing due to virus scanning.

### Description of the Related art

Electrophotographic image forming apparatuses includes multifunction peripherals (MFPs), facsimiles, copiers, and printers having a scanner function, a facsimile function, a copying function, a function as a printer, a data communication function, and a server function.

Generally, operating systems (OSs) of personal computers (PCs) have a function to automatically (without instructions by a user) execute a specific file stored in the external storage when an external storage such as a universal serial bus (USB) memory is installed. In order to prevent infection with a virus, the PC first confirms that the file is not infected with a virus by virus scanning and then executes the file.

Meanwhile, image forming apparatuses generally do not have a function to automatically execute a file stored in an external storage that is installed to the image forming apparatus. However, image forming apparatuses perform operation such as printing a file stored in an external storage or storing the file in a box area in the image forming apparatus (a storage area that a user can use in a storage device mounted in the image forming apparatus) when an instruction is given by the user. Image forming apparatuses perform virus scanning of a target file before the operation when operation using a file stored in an external storage is performed in accordance with a user instruction as described above.

Note that technology relating to virus scanning in an image forming apparatus is disclosed in JP 2006-256104 A, JP 2006-41740 A. JP 2003-182166 A, and the like. JP 2006-256104 A discloses a printer that, in a case where data received from a client PC is held in a memory, notifies on a panel that there is a virus and prevents secondary infection with the virus in the data stored in the memory when a control program executed by the main central processing unit (CPU) detects that there is a virus in the data.

JP 2006-41740 discloses technology in which, in an image forming system including an MFP and an external device, the external device constantly monitors access from a network and detects a virus. When a virus is detected, the external device notifies the MFP that the virus has been detected, and requests the MFP to make an announcement by a predetermined method of announcement. The MFP announces that a virus has been detected by the specified method of announcement.

JP 2003-182166 discloses technology in which a peripheral device including, an embedded controller device scans for viruses, determines whether transmitted information substantially includes a virus and if no virus is detected, prints out the information.

Image forming apparatuses of the related art performs virus scanning on a file to be printed stored in an external storage When an instruction to execute printing is received from a user, and starts printing the file to be printed after the virus scanning is completed. For this reason, there are disadvantages that it takes time to start printing and that printing is delayed due to the virus scanning.

Meanwhile, it is also conceivable that the image forming apparatus automatically executes virus scanning on files stored in the external storage when an external storage is installed to an image forming apparatus. However, in this configuration, each of the multiple files is randomly scanned for viruses in a case where multiple files are stored in the external storage, and thus there may be cases in which a file to be printed is not scanned for viruses but only files that are not to be printed are scanned. As a result, there is a disadvantage that unnecessary processing of an image forming apparatus increases and that printing is delayed due to the virus scanning.

### SUMMARY

The present invention solves the above disadvantages, and an object of the invention is to provide an image forming apparatus and a control program for the image forming apparatus capable of suppressing delay in printing due to virus scanning.

To achieve the abovementioned object, according to an aspect of the present invention, an image forming apparatus reflecting one aspect of the present invention comprises: a hardware processor that detects multiple files stored in the external storage when an external storage is installed to the image forming apparatus, determines a scan order of each of the multiple files detected by the hardware processor, and scans each of the multiple files for viruses in the scan order; and an acceptor that accepts a print instruction for a file stored in the external storage, wherein the hardware processor determines whether it is necessary to execute virus scanning on a print target file before printing depending on whether the hardware processor has completed virus scanning on the print target file, which is the file for which the print instruction has been accepted by the acceptor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of an image processing system according to a first embodiment of the present invention;

FIG. 2 is a block diagram illustrating an internal configuration of an image forming apparatus in the first embodiment of the present invention;

FIG. 3 is a diagram schematically illustrating data exchange between the image forming apparatus of the first embodiment of the present invention and other devices;

FIG. 4 is a flowchart illustrating the operation of the image forming apparatus when a USB memory is installed in the first embodiment of the present invention; FIG. 5 is a flowchart illustrating a subroutine of virus scanning processing (S5 in FIG. 4) in the first embodiment of the present invention;

FIG. 6 is a diagram schematically illustrating a detection result of files in step S11 of FIG. 5 in the first embodiment of the present invention;

FIG. 7 is a flowchart illustrating a subroutine of scan order determining processing (step S13 in FIG. 5) in the first embodiment of the present invention;

FIG. 8 is a diagram schematically illustrating a default priority table in the first embodiment of the present invention;

FIG. 9 is a diagram schematically illustrating a scan table generated in the scan order determining processing (S13 in FIG. 5) in the first embodiment of the present invention;

FIG. 10 is a flowchart illustrating the operation of the image forming apparatus when printing is executed in the first embodiment of the present invention;

FIG. 11 is a flowchart illustrating a subroutine of the scan order determining processing (S13 in FIG. 5) when a default priority table is corrected on the basis of the number of files of a file format included in a print history of an image forming apparatus in a second embodiment of the present invention;

FIG. 12 is a diagram schematically illustrating a print history stored in a fixed storage device in the second embodiment of the present invention;

FIG. 13 is a diagram schematically illustrating a priority table corrected on the basis of the number of files of a file format included in the print history of the image forming apparatus in the second embodiment of the present invention;

FIG. 14 is a diagram schematically illustrating a scan table generated by the scan order determining processing (S13 in FIG. 5) on the basis of the corrected priority table illustrated in FIG. 13 in the second embodiment of the present invention;

FIG. 15 is a flowchart illustrating a subroutine of the scan order determining processing (S13 in FIG. 5) when a default priority table is corrected on the basis of the number of files of a file format in which a virus has been detected in the second embodiment of the present invention;

FIG. 16 is a diagram schematically illustrating a virus detection history stored in a fixed storage device in the second embodiment of the present invention;

FIG. 17 is a diagram schematically illustrating a priority table corrected on the basis of the number of files of a file format in which a vines has been detected in the second embodiment of the present invention;

FIG. 18 is a diagram schematically illustrating a scan table generated by the scan order determining processing (S13 in FIG. 5) on the basis of the corrected priority table illustrated in FIG. 17 in the second embodiment of the present invention;

FIG. 19 is a flowchart illustrating a subroutine of scan order correcting processing (S15 in FIG. 5) in a first example of a third embodiment of the present invention;

FIG. 20 is a diagram schematically illustrating a scan table corrected in the scan order correcting processing (S15 in FIG. 5) in the first example of the third embodiment of the present invention;

FIG. 21 is a flowchart illustrating a subroutine of the scan order correcting processing (S15 in FIG. 5) in a second example of the third embodiment of the present invention;

FIG. 22 is a diagram schematically illustrating a scan table corrected in the scan order correcting processing (S15 in FIG. 5) in the second example of the third embodiment of the present invention;

FIG. 23 is a flowchart illustrating a subroutine of the scan order correcting processing (S15 in FIG. 5) in a third example of the third embodiment of the present invention;

FIG. 24 is a diagram schematically illustrating a scan table corrected in the scan order correcting processing (S15 in FIG. 5) in the third example of the third embodiment of the present invention;

FIG. 25 is a flowchart illustrating a subroutine of the scan order correcting processing (S15 in FIG. 5) in a fourth example of the third embodiment of the present invention;

FIG. 26 is a diagram schematically illustrating a scan table corrected in the scan order correcting processing (S15 in FIG. 5) in the fourth example of the third embodiment of the present invention;

FIG. 27 is a flowchart illustrating a subroutine of the scan order correcting processing (S15 in FIG. 5) in a fifth example of the third embodiment of the present invention;

FIG. 28 is a diagram schematically illustrating a scan table corrected in the scan order correcting processing (S15 in FIG. 5) in the fifth example of the third embodiment of the present invention;

FIG. 29 is a flowchart illustrating a subroutine of the scan order correcting processing (S15 in FIG. 5) in a sixth example of the third embodiment of the present invention;

FIG. 30 is a diagram schematically illustrating a scan table corrected in the scan order correcting processing (S15 in FIG. 5) in the sixth example of the third embodiment of the present invention;

FIG. 31 is a flowchart illustrating a subroutine of the scan order correcting processing (S15 in FIG. 5) in a seventh example of the third embodiment of the present invention;

FIG. 32 is a diagram schematically illustrating a scan table corrected in the scan order correcting processing (S15 in FIG. 5) in the seventh example of the third embodiment of the present invention

FIG. 33 is a flowchart illustrating a subroutine of the scan order modifying processing (S33 in FIG. 5) in a first example of a fourth embodiment of the present invention;

FIG. 34 is a diagram schematically illustrating a scan table after the scan order has been modified in scan order modifying processing (S33 in FIG. 5) in the first example of the fourth embodiment of the present invention;

FIG. 35 is a flowchart illustrating a subroutine of the scan order modifying processing (S33 in FIG. 5) in a second example of the fourth embodiment of the present invention;

FIG. 36 is a diagram schematically illustrating a scan table after the scan order has been modified in the scan order modifying processing (S33 in FIG. 5) in the second example of the fourth embodiment of the present invention;

FIG. 37 is a flowchart illustrating scan stop flag setting processing executed by an image forming apparatus in a first example of a fifth embodiment of the present invention;

FIG. 38 is a flowchart illustrating the scan stop flag setting processing executed by the image forming apparatus in a second example of the fifth embodiment of the present invention;

FIG. 39 is a diagram illustrating an exemplary file list stored in a USB memory that is displayed on a display in a sixth embodiment of the present invention; and

FIG. 40 is a flowchart illustrating display processing a file list executed by an image forming apparatus in the sixth embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

In the following embodiments, cases where an image forming apparatus is an MFP will be described. An image forming apparatus may be a facsimile, a copier, or a printer other than an MFP.

### First Embodiment

Configuration of Image Forming Apparatus

First, a configuration of an image forming apparatus will be described.

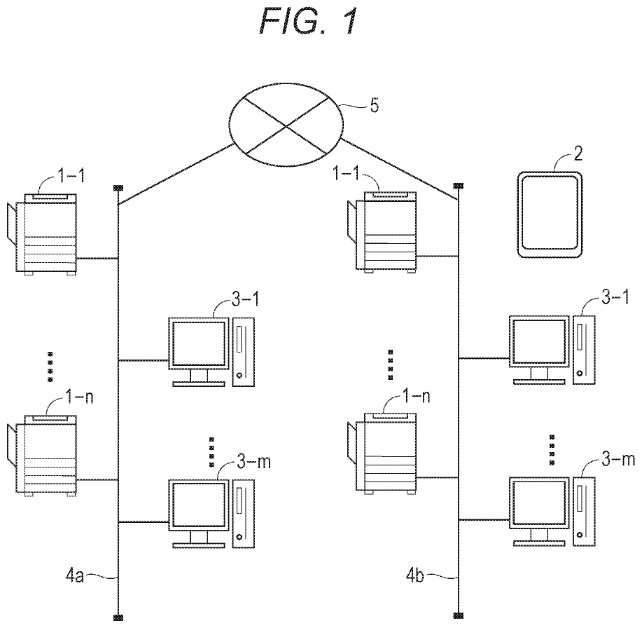

FIG. 1 is a diagram illustrating a schematic configuration of an image processing system according to a first embodiment of the present invention.

Referring to FIG. 1, the image processing system includes n (where n is a natural number) image forming apparatuses 1-1 to 1-n, a mobile terminal 2, and m (where m is a natural number) information processing devices 3-1 to 3-m. Each of the image forming apparatuses 1, the mobile terminal 2, and each of the information processing devices 3 are connected to each other through a network 4a. The network 4a is connected to another network 4b via an external network 5.

Any of the image forming apparatuses 1-1 to 1-n may be referred to as (an) image forming apparatus(es) 1 (an example of an image forming apparatus). Any of the information processing devices 3-1 to 3-m may be referred to as (an) information processing device(s) 3. Moreover, any of the networks 4a and 4b may be referred to as (a) network(s) 4.

A network 4 may use any one of a dedicated line such as a wired or wireless local area network (LAN), a general line, or wireless communication. The networks 4 connect various devices using the transmission control protocol/internet protocol (TCP/IP). Devices connected, to a network 4 can exchange various types of data with each other. Note that a network 4 may use a general line or wireless communication.

An image forming apparatus it forms, on a sheet of paper, a copy image of a scanned document image or a copy image of an image generated on the basis of print data received from an information processing device 3. Print data is obtained by, for example, converting a drawing command issued by the operating system or an application program of an information processing device 3 into a page description language that can be processed by an image forming apparatus 1 by a printer driver. Print data may be document data described in a file format such as PDF, TIFF, JPEG, or XPS.

An image forming apparatus 1 can also transmit a document image to an information processing device 3 or another image forming apparatus 1 via the network 4. An image forming apparatus 1 can also transmit a document image to another image forming apparatus 1 or an information processing device 3 connected to another network 4 via the external network 5. Moreover, an image forming apparatus 1 can also accumulate document images or document data received from an information processing device 3 in a fixed storage device in the image forming apparatus 1.

The mobile terminal 2 is a portable computer including a central processing unit (CPU), a random access memory (RAM), a fixed storage device, a monitor, and a touch-operable liquid crystal display (LCD) panel. With the mobile terminal 2, it is possible to accumulate electronized documents in a fixed storage device to early, to view, and to edit the documents at any place. The mobile terminal 2 has a wireless communicator, and can send and receive documents to and from an image forming apparatus 1 or an information processing device 3.

An information processing device 3 is a general computer device including a CPU, a RAM, a fixed storage device (such as a hard disk device), a monitor, a keyboard, and a mouse. An information processing device 3 generates print data in accordance with a user instruction and transmits the generated print data to an image forming apparatus 1.

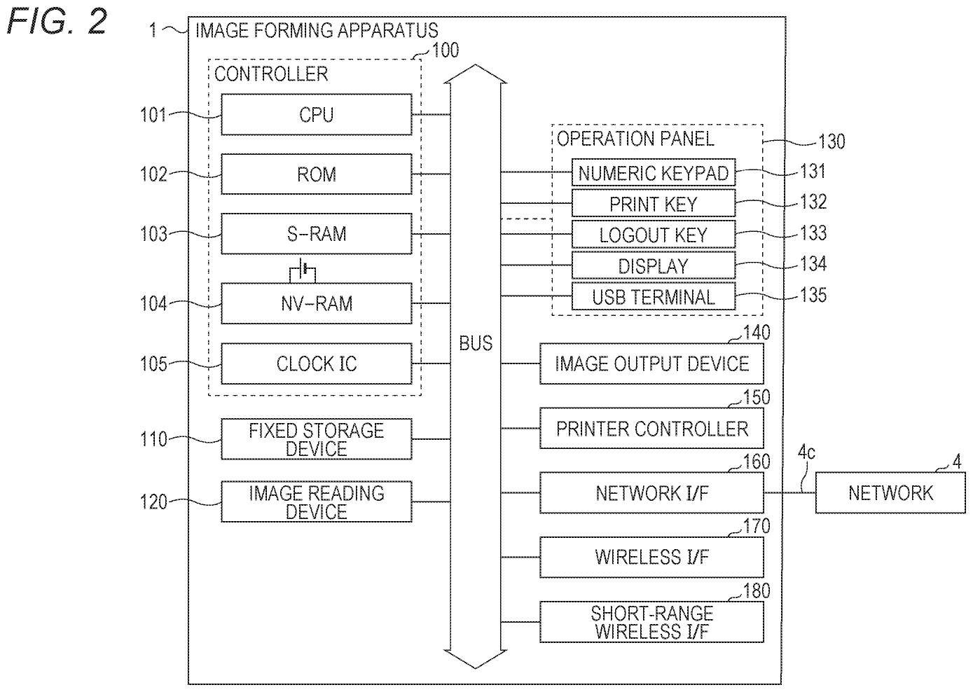

FIG. 2 is a block diagram illustrating an internal configuration of an image forming apparatus 1 in the first embodiment of the present invention.

Referring to FIG. 2, the image forming apparatus 1 includes a CPU 101 (an example of a detector, an order determiner, a virus scanner, an execution necessity determiner, a corrector, a first order modifier, and a second order modifier), a ROM 102 (an example of a priority storage), a static random access memory (SRAM) 103, a non-volatile random access memory (NVRAM) 104, a clock integrated circuit (IC) 105, a fixed storage device 110 (an example of a specified folder storage, a specified character string storage, an excluded folder storage, and an excluded character string storage), an image reading device 120, an operation panel 130 (an example of a maintenance screen display), an image output device 140, a printer controller 150, a network interface 160, a wireless interface 170, and a short-range wireless interface 180.

The CPU 101 is connected with each of the ROM 102, the SRAM 103, the NVRAM 104, and the clock IC 105 via a bus. The CPU 101, the ROM 102, the SRAM 103, the NVRAM 104, and the clock IC 105 form a controller 100.

The CPU 101 controls the operation of the image forming apparatus 1 in accordance with a control program.

The ROM 102 stores the control program.

The SRAM 103 is a working memory for the CPU 101.

The NVRAM 104 stores various settings related to image formation by battery backup.

The controller 100 is connected with each of the fixed storage device 110, the image reading device 120, the operation panel 130, the image output device 140, the printer controller 150, the network interface 160, the wireless interface 170, and the short-range wireless interface 180 (an example of a receiver).

The fixed storage device 110 is, for example, a hard disk device, and stores various types of information such as a print history and a virus detection history.

The image reading device 120 reads a document image.

The operation panel 130 includes a numeric keypad 131 for inputting numbers, a print key 132 (an example of an acceptor) that accepts a print instruction, a logout key 133 that accepts a logout instruction from a user, and a display 134 (an example of a folder display, a file display, a list display, and a mode acceptor), and a USB terminal 135. The display 134 is a touch-panel type liquid crystal display (LCD), displays various types of information, and accepts various types of operation.

A USB memory is installed to the USB terminal 135 manually by a user as necessary. The USB memory can be attached to and detached from the USB terminal 135.

The image output device 140 forms a copy image on a sheet of paper.

The printer controller 150 generates a copy image from print data received by the network interface 160.

The network interface 160 connects the image forming apparatus 1 to a network 4 via a network cable 4c. The network interface 160 transmits and receives various types of information to and from external devices such as other image forming apparatuses 1, the mobile terminal 2, or information processing devices 3.

The wireless interface 170 performs wireless communication with external devices such as other image forming apparatuses 1, the mobile terminal 2, or information processing devices 3.

The short-range wireless interface 180 is used for short-range wireless communication such as NFC, Bluetooth (registered trademark), or IrDA (registered trademark), and is mainly used for short-range wireless communication with the mobile terminal 2. The short-range wireless interface 180 may be disposed, for example, in a paper ejector where printed paper is discharged, in the vicinity of the operation panel 130, or at a part opposite to the paper ejector.

Data Exchange Performed by Image Forming Apparatus

First, data exchange performed by an image forming apparatus according to the present embodiment will be described.

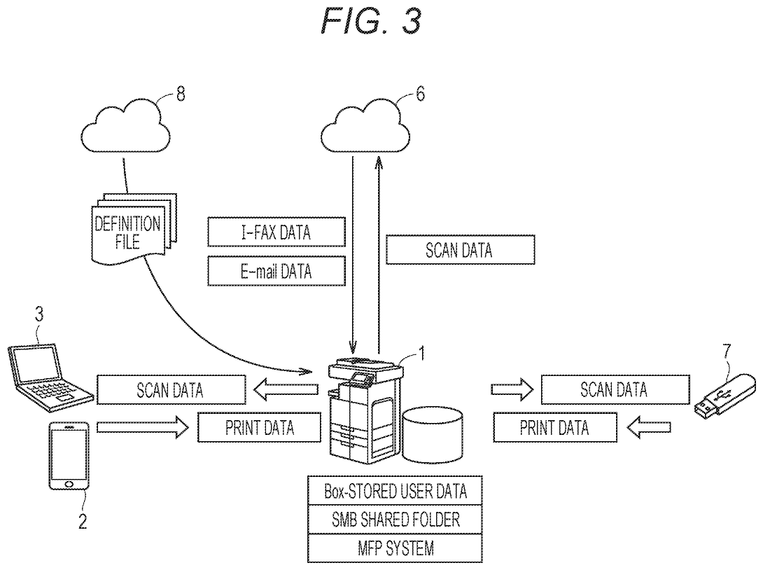

FIG. 3 is a diagram schematically illustrating data exchange between an image forming apparatus 1 of the first embodiment of the present invention and other devices.

Referring to FIG. 3, a fixed storage device 110 of the image forming apparatus 1 stores user data of the image forming apparatus 1 stored in a box area, a server message block (SMB) shared folder, system data of the image forming apparatus 1, etc.

The image forming apparatus 1 receives a virus definition file used for virus scanning at a necessary timing from the cloud server 8 on the external network 5 and stores the file in the fixed storage device 110.

The image forming apparatus 1 transmits scan data, which is data of a document image read by the image reading device 120, to the mobile terminal 2 or an information processing device 3 through a network 4. The image forming apparatus 1 also receives print data, which is data of a file to be printed, from the mobile terminal 2 or the information processing device 3 through the network 4.

The image forming apparatus 1 transmits scan data or the like to the cloud server 6 on the external network 5 and stores the data in a storage area in the cloud server 6. The image forming apparatus 1 also acquires reception data of an Internet fax, reception data of an e-mail, and the like from a storage area in the cloud server 6 on the external network 5.

In addition, the image forming apparatus 1 stores scan data and the like in a USB memory 7 installed to the USB terminal 135. The image forming apparatus 1 also acquires print data and the like from the USB memory 7 installed to the USB terminal 135.

As described above, the image forming apparatus 1 acquires data from various devices such as the mobile terminal 2, the information processing device 3, the cloud server 6, or the USB memory 7. For this reason, there are various routes through which the image forming apparatus 1 becomes infected with a virus.

In this example, there is a high possibility that a file stored in the USB memory 7 is infected with a virus, and the USB memory 7 is the path with the highest risk of virus infection for the image forming apparatus 1.

Therefore, in the present embodiment, the operation of the image forming apparatus 1 to perform virus scanning on a file stored in the USB memory 7 will be described.

When the USB memory 7 is installed to the USB terminal 135, the image forming apparatus 1 detects a plurality of files stored in the USB memory 7, and determines the scan order of the detected respective files. The image forming apparatus 1 scans each of the multiple files for viruses in the determined scan order.

(Operation of Image Forming Apparatus When USB Memory is Installed)

Next, the operation of an image forming apparatus when a USB memory is installed will be described.

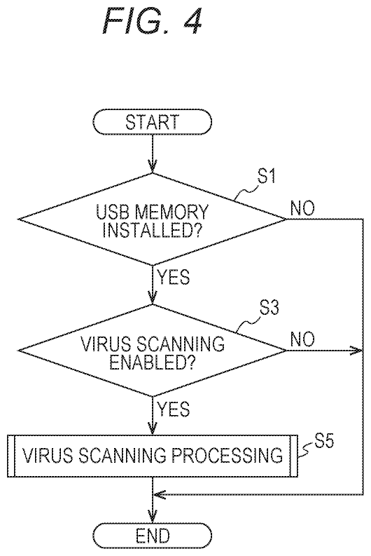

FIG. 4 is a flowchart illustrating the operation of the image forming apparatus 1 when a USB memory is installed in the first embodiment of the present invention.

Referring to FIG. 4, the CPU 101 determines whether a USB memory (external storage) is installed to USB terminal 135 (S1).

If it is determined in step S1 that the USB memory is installed to the USB terminal 135 (YES in S1), the CPU 101 determines whether virus scanning setting is enabled (S3).

The image forming apparatus 1 accepts in advance settings as to whether to automatically execute virus scanning on a file stored in the USB memory (without user instruction) when a USB memory is installed. This setting is performed by an administrator or the like of the image forming apparatus 1. If setting of automatic execution of virus scanning is made, it is determined in step S3 that the virus scanning setting is enabled. If the setting of automatic execution of virus scanning is not made, it is determined in step S3 that the virus scanning setting is disabled.

If it is determined in step S3 that the virus scanning setting is enabled (YES in S3), the CPU 101 executes virus scanning processing described later (S5) and ends the processing.

If it is determined in step S1 that no USB memory is installed to the USB terminal 135 (NO in S1), or if it is determined in step S3 that the virus scanning setting is disabled (NO in S3), the CPU 101 ends the processing.

FIG. 5 is a flowchart illustrating a subroutine of the virus scanning processing (S5 in FIG. 4) in the first embodiment of the present invention.

Referring to FIG. 5, the CPU 101 detects files stored in the USB memory in the virus scanning processing (S11). Next, the CPU 101 determines the scan order of the respective files by performing scan order determining processing, and generates a scan table (S13). Next, the CPU 101 corrects the determined scan order by performing scan order correcting processing as necessary (S15). Then, the CPU 101 sets the first file in the scan order as a target file of virus scanning (S17), and refers to the scan table to determine whether the target file has been scanned for viruses (S19).

If it is determined in step S19 that the target file has been canned for viruses (YES in S19), the CPU 101 proceeds to processing of step S25.

If it is determined in step S19 that the target file has not been scanned for viruses (NO in S19), the CPU 101 scans the target file for viruses (S21), and stores the virus scanning results in the scan table (S23). Next, the CPU 101 determines whether virus scanning has been completed for all files listed in the scan table (S25).

If it is determined in step S25 that virus scanning has not been completed for all files listed in the scan table (NO in S25), the CPU 101 sets a file of the next scan order as a target file (S27), and determines whether predetermined operation has been accepted (S31).

If it is determined in step S31 that the predetermined operation has been accepted (YES in S31), the CPU 101 modifies the scan order of files in the scan table by performing scan order modifying processing as necessary (S33) and then proceeds to the processing of S19.

If it is determined in step S31 that the predetermined operation has not been accepted (NO in S31), the CPU 101 determines whether virus scan stop flag is set (S35).

If it is determined in step S35 that the virus scan stop flag is not set (NO in S35), the CPU 101 proceeds to the processing of step S19.

If it is determined in step S25 that virus scanning has been completed for all the files listed in the scan table (YES in S25), or if it is determined in step S35 that the virus scan stop flag is set (YES in S35), the CPU 101 returns from the subroutine.

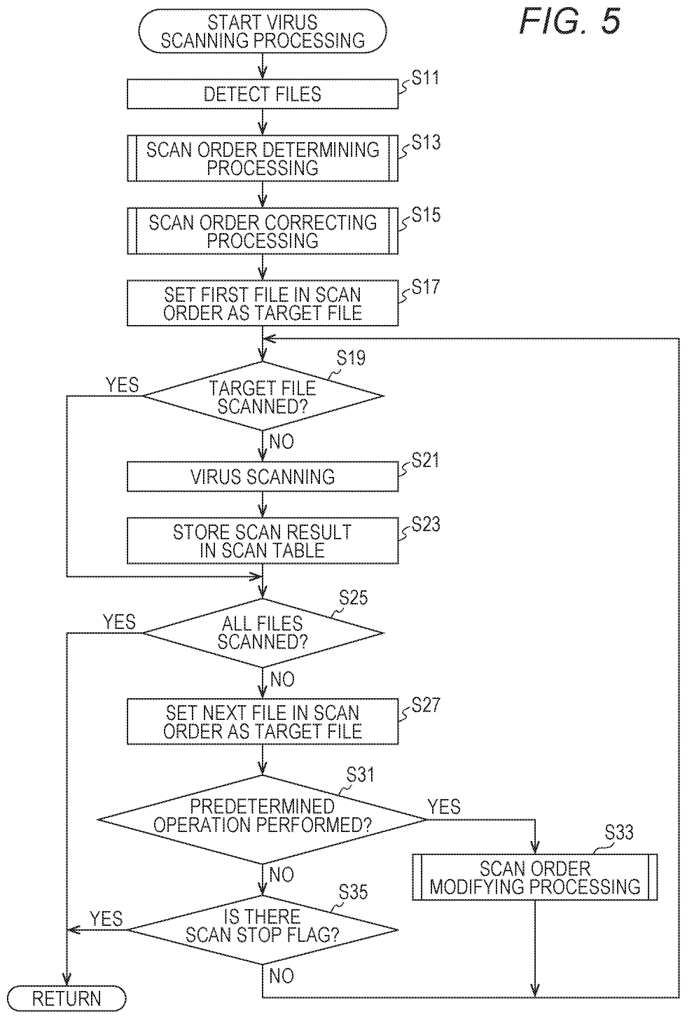

FIG. 6 is a diagram schematically illustrating a detection result of files in step S11 of FIG. 5 in the first embodiment of the present invention.

Referring to FIG. 6, the detection result of files is generated when the USB memory is installed to the image forming apparatus 1 and stored in the fixed storage device 110. The detection result of files is erased from the fixed storage device 110 when the USB memory is removed from the image forming apparatus 1.

Here, seventeen files are detected from the USB memory. The detection result of files indicates the detection number (number indicating the order of detection), the file path (storage location of a file in the USB memory), the file name, and the date of update of the detected files.

As an example, it can be understood that a file with a detection number “7” and a file name “test21.pdf” is stored in a folder “user1” and has been updated on “Feb. 7, 2018.”

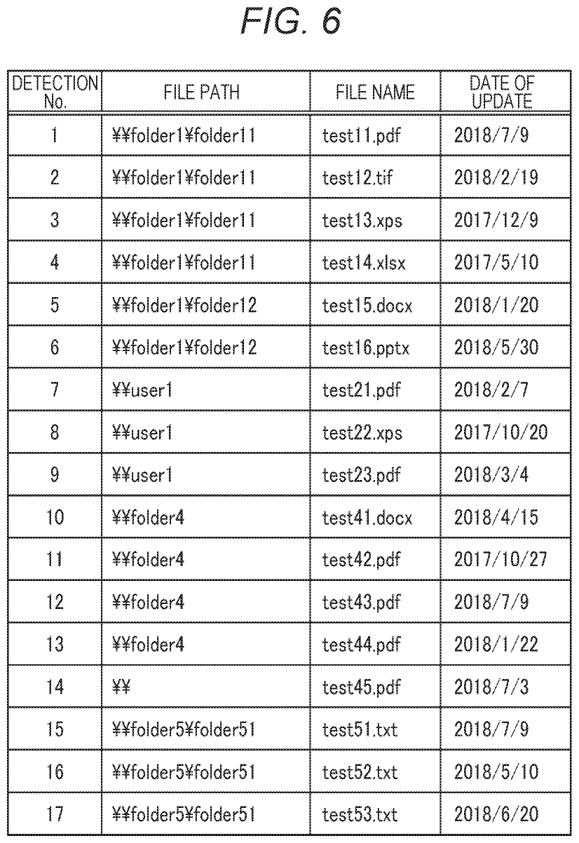

FIG. 7 is a diagram illustrating a subroutine of the scan order determining processing (step S13 in FIG. 5) in the first embodiment of the present invention.

Referring to FIG. 7, the CPU 101 reads a default priority table (an example of first priority information) in the scan order determining processing in step S13 of FIG. 5 (S41), and reads information of a file of a detection number “1” from a file search result (S43). Next, the CPU 101 writes file information in the scan table in accordance with the default priority table (S45). In step S45, the file information is written in the scan table so that the scan order of the files is arranged in the order of priority file formats listed in the default priority table. Then, the CPU 101 determines whether information of all the files has been written to the scan table (S47).

If it is determined in step S47 that information of all the files has not been written to the scan table (NO in S47), the CPU 101 reads information of the file of the next detection number (S49) and proceeds to the processing of step S45.

If it is determined in step S47 that information of all the files has been written to the scan table (YES in S47), the CPU 101 returns from the subroutine.

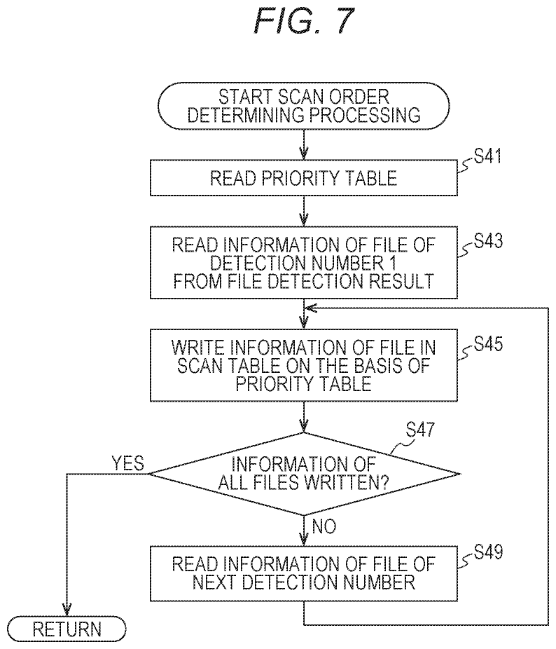

FIG. 8 is a diagram schematically illustrating a default priority table in the first embodiment of the present invention.

Referring to FIG. 8, a priority table is a table describing information indicating the relationship between the file format and the priority. A default priority table (an example of first priority information) is stored in the ROM 102. The order of priority specified in a default priority table is a default order of priority of file formats. The lower the number of the priority is, the higher the priority is. As will be described later, a priority table (order of priority of file formats) may be corrected in the scan order correcting processing (S15) illustrated in FIG. 5. In the present embodiment, the scan order of files detected from the USB memory is determined on the basis of the default priority table and written in the scan table.

Here, the default priority table specifies the order of priority of file formats in the order of “PDF,” “docx,” “pptx,” “TIFF,” “PCL,” “PS,” “xlsx,” “TEXT,” and “XPS” in descending order of priority

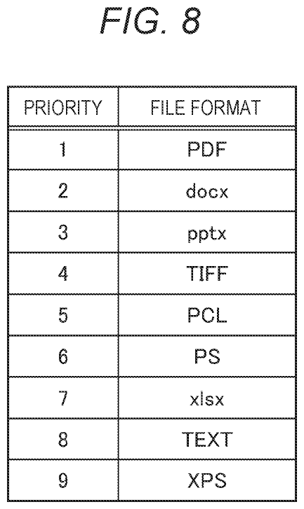

FIG. 9 is a diagram schematically illustrating a scan table generated in the scan order determining processing (S13 in FIG. 5) in the first embodiment of the present invention.

Referring to FIG. 9, a scan table is a table describing the scan order of files detected from the USB memory. The scan table is generated when the USB memory is installed to the image forming apparatus 1 and is stored in the fixed storage device 110. The scan table is erased from the fixed storage device 110 when the USB memory is removed from the image forming apparatus 1.

The scan table indicates the scan order, the detection number, the file path, the file name, and the scan result of files detected from the USB memory. In the present embodiment, the higher the priority specified in the default priority table a file format of a file is, the earlier the scan order becomes (the smaller the number becomes).

Here, a scan table immediately after the scan order determining processing is illustrated. Since virus scanning has not started yet immediately after the scan order determining processing, characters “N/A” indicating that virus scanning has not been completed are entered in the scan result fields of all files. When virus scanning of a file is completed, the scan result field for that file in the scan table is updated to a character of “completed” indicating that the virus scanning has been completed and that no virus has been detected, or to a character of “detected” indicating that the virus scanning has been completed and that a virus has been detected.

Operation of Image Forming Apparatus When Printing is Executed

Next, the operation of the image forming apparatus when executing printing will be described.

The image forming apparatus 1 receives a print instruction for a file stored in the USB memory through the print key 132. When receiving the print instruction, the image forming apparatus 1 determines whether it is necessary to execute virus scanning on a print target file before printing depending on whether virus scanning is completed on the print target file for which the print instruction has been received.

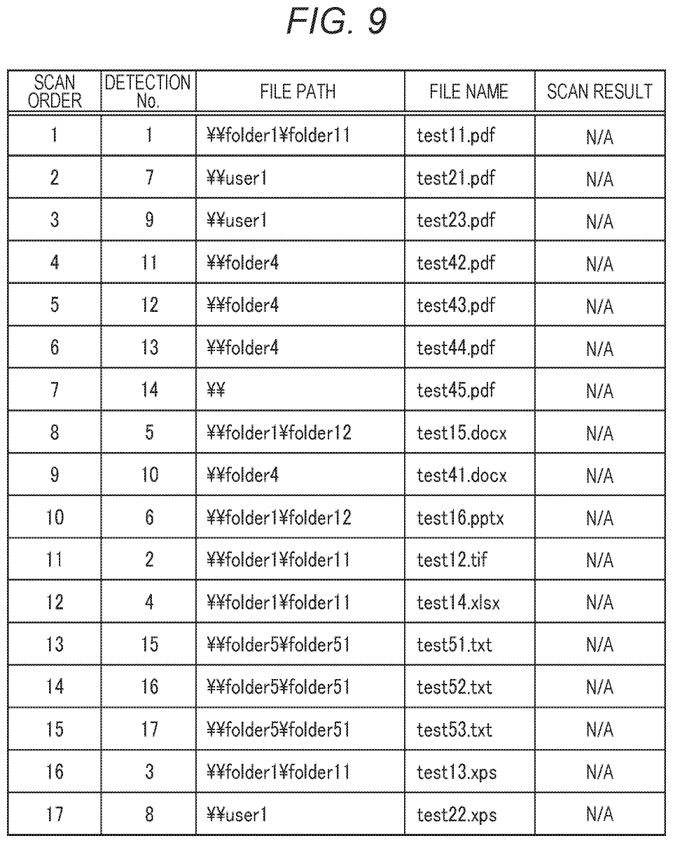

FIG. 10 is a flowchart illustrating the operation of the image forming apparatus 1 when printing is executed in the first embodiment of the present invention.

Referring to FIG. 10, the CPU 101 accepts selection of a print target file from files stored in the USB memory, and accepts setting of print conditions (the number of copies, double-sided printing or single-sided printing, or post-processing such as stapling) (S51), and then determines whether a print instruction has been accepted through the print key 132 (S53). The CPU 101 repeats the processing of step S53 until it is determined that a print instruction has been accepted.

If it is determined in step S53 that a print instruction has been accepted (YES in S53), the CPU 101 refers to the scan table and reads the virus scanning status of the print target file (S55). Next, the CPU 101 determines whether virus scanning of the print target file has been completed (S57).

If it is determined in step S57 that virus scanning of the print target file has not been completed (NO in S57), the CPU 101 determines that it is necessary to execute virus scanning on the print target file before printing, and scans the print target file for viruses (S59).

Note that, in a case where virus scanning (S19 in FIG. 5) associated with installation of the USB memory is being executed when virus scanning of the print target file is executed in step S59, the virus scanning accompanying the installation of the USB memory may be halted.

Then, the CPU 101 executes printing (S61), records the printing result in a print history (S63), and ends the processing.

If it is determined in step S57 that virus scanning of the print target file has been completed (YES in S57), the CPU 101 determines that it is not necessary to execute virus scanning on the print target file before printing. The CPU 101 executes printing without scanning the print target file for viruses (S61), records the printing result in a print history (S63), and ends the processing.

According to the present embodiment, the scan order of respective files detected from the USB memory is determined when a USB memory is installed to the image forming apparatus 1, and virus scanning is executed on each of the respective files one by one in a determined scan order, and thus it is possible to increase the possibility of completing virus scanning of a file before acceptance of a print instruction for the file stored in the USB memory. As a result, it is possible to shorten a time period from acceptance of the print instruction the start of printing, and thus it is possible to suppress the delay in printing due to virus scanning.

In addition, since the scan order is determined on the basis of the priority table that illustrates the relationship between the file format and the priority, it is possible to perform virus scanning preferentially on a file of a file format that is frequently printed or a file format from which a virus is often detected.

### Second Embodiment

In the present embodiment, an example will be described in which a corrected priority table (an example of second priority information) that is information indicating the relationship between the file format and the priority is generated by correcting a default priority table, and the scan order is determined on the basis of the corrected priority table. Correction of the priority table may be performed on the basis of the number of files of a file format included in a print history of an image forming apparatus 1, as will be described below.

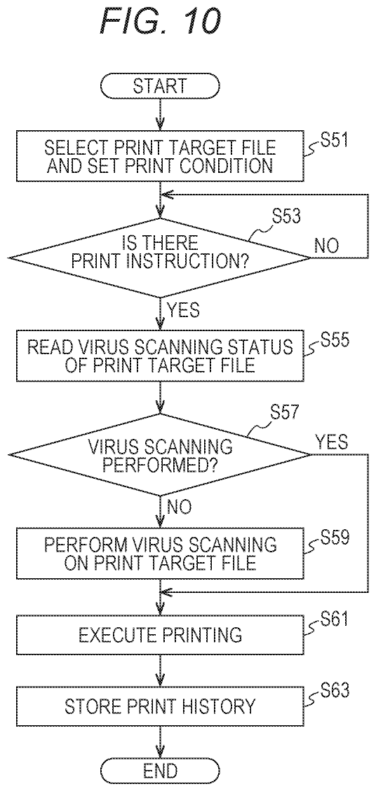

FIG. 11 is a flowchart illustrating a subroutine of the scan order determining processing (S13 in FIG. 5) when a default priority table is corrected on the basis of the number of files of a file format included in a print history of the image forming apparatus 1 in the second embodiment of the present invention.

Referring to FIG. 11, a CPU 101 reads a default priority table (S71) and reads a print history in the scan order determining processing in step S13 of FIG. 5 (S73). Subsequently, the CPU 101 corrects the default priority table on the basis of the print history so that the priority of a file format becomes higher as the number of files of the file format included in the print history is large (S75). Next, the CPU 101 reads information of the file of a detection number “1” from a file search result (S77) and writes the information of the file to the scan table in accordance with the corrected priority table (S79). Then, the CPU 101 determines whether information of all the files has been written to the scan table (S81).

If it is determined in step S81 that information of all the files has not been written to the scan table (NO in S81), the CPU 101 reads information of the file of the next detection number (S83) and proceeds to the processing of step S79.

If it is determined in step S81 that information of all the files has been written o the scan table (YES in S81), the CPU 101 returns from the subroutine.

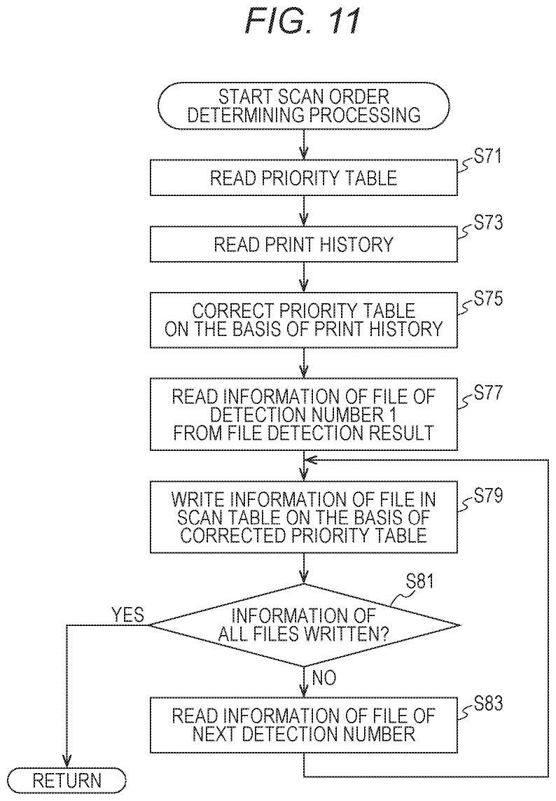

FIG. 12 is a diagram schematically illustrating a print history stored in a fixed storage device 110 in the second embodiment of the present invention.

Referring to FIG. 12, this print history lists file formats of print files executed before by the image forming apparatus 1, the number of times of printing of files of the file formats, and the priority listed in the default priority table. For example, the file format “PDF” has the number of times of printing of “1229” and the priority listed in the default priority table of “1.”

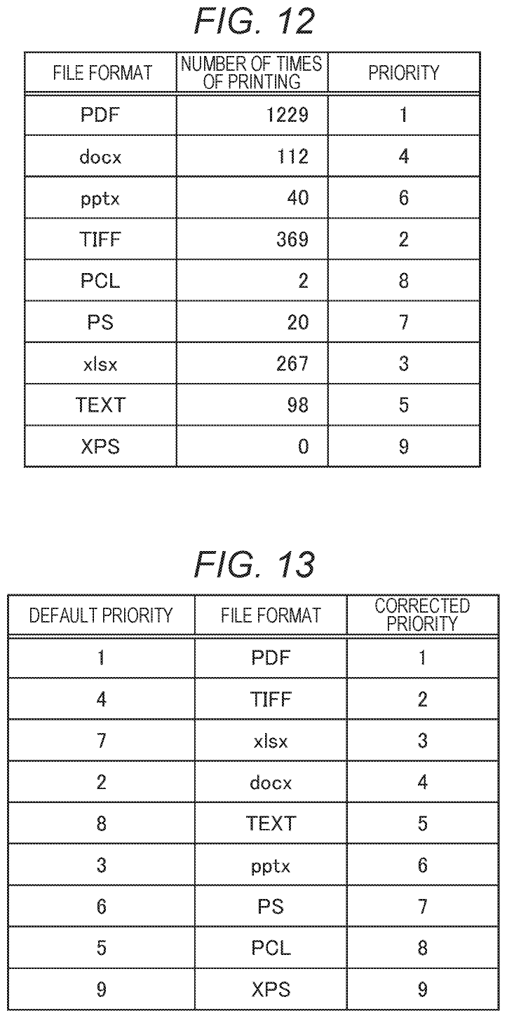

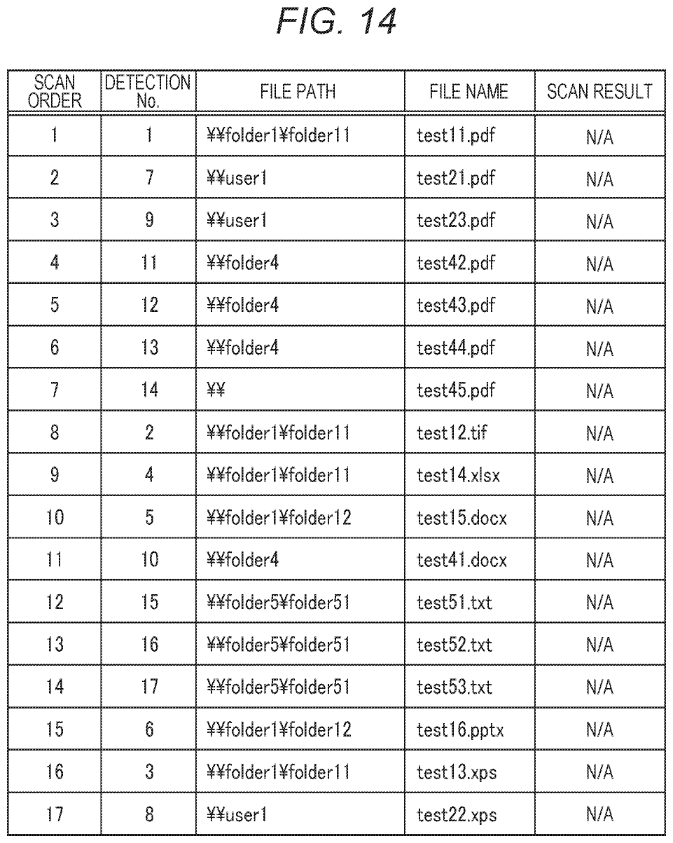

FIG. 13 is a diagram schematically illustrating a priority table corrected on the basis of the number of files of a file format included in the print history of the image forming apparatus 1 in the second embodiment of the present invention. FIG. 14 is a diagram schematically illustrating a scan table generated by the scan order determining processing (S13 in FIG. 5) on the basis of the corrected priority table illustrated in FIG. 13 in the second embodiment of the present invention.

Referring to FIG. 13, the priority of each file format is corrected so that the priority of a file format having a high printing frequency becomes higher than the priority of a file format having a low printing frequency.

Referring to FIG. 13, the order of file formats in the print history in descending order of the number of times of printing is “PDF,” “TIFF,” “xlsx,” “docx.” “TEXT,” “pox,” “PS,” “PCL,” and “XPS.” Therefore, the priority of each of the file formats is corrected so that the file formats are listed in the order of “PDF,” “TIFF,” “xlsx,” “docx,” “TEXT,” “pptx,” “PS,” “PCL,” and “XPS” in descending order of priority.

As a result, as illustrated in FIG. 14, the higher the priority specified in the corrected priority table a file format of a file is, the earlier the scan order becomes (the smaller the number becomes).

Alternatively, correction of the priority table may be performed on the basis of the number of files of a file format in which a virus has been detected, as will be described below.

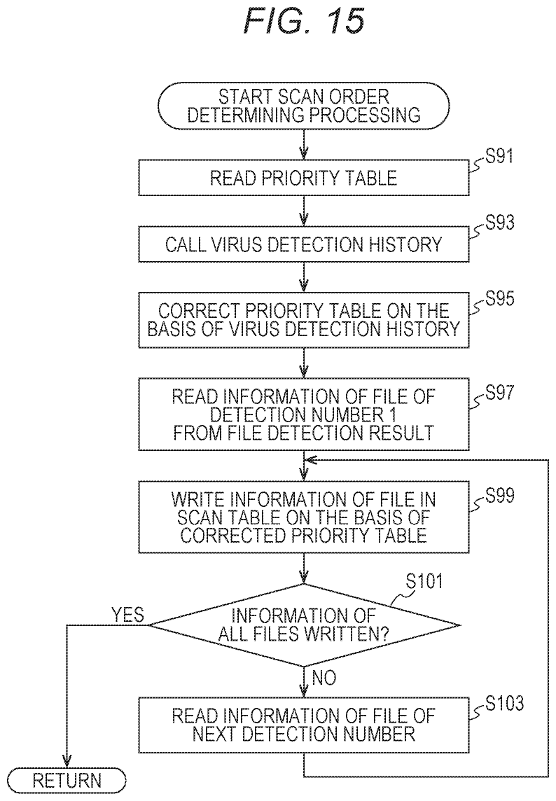

FIG. 15 is a flowchart illustrating a subroutine of the scan order determining processing (S13 in FIG. 5) when a default priority table is corrected on the basis of the number of files of a file format in which a virus has been detected in the second embodiment of the present invention.

Referring to FIG. 15, the CPU 101 reads a default priority table (S91) and reads a virus detection history (S93) in the scan order determining processing in step S13 of FIG. 5. Subsequently, the CPU 101 corrects the default priority table on the basis of the virus detection history (S95). Next, the CPU 101 reads information of the file of a detection number “1” from a file search result (S97) and writes the information of the file to the scan table in accordance with the corrected priority table (S99). Then, the CPU 101 determines whether information of all the files has been written to the scan table (S101).

If it is determined in step S101 that information of all the files has not been written to the scan table (NO in S101), the CPU 101 reads information of the file of the next detection number (S103) and proceeds to the processing of step S99.

If it is determined in step S101 that information of all the files has been written to the scan table (YES in S101), the CPU 101 returns from the subroutine.

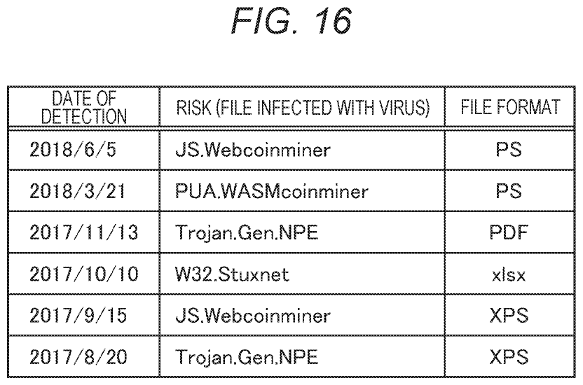

FIG. 16 is a diagram schematically illustrating a virus detection history stored in the fixed storage device 110 in the second embodiment of the present invention.

Referring to FIG. 16, the virus detection history lists the date when the image forming apparatus 1 has detected a virus, the name of the file infected with the virus, and the file format of the file infected with the virus. For example, it can be understood that a file with the file format “PS” having a file name “JS.Webcoinminer” was detected on “Jun. 5, 2018.”

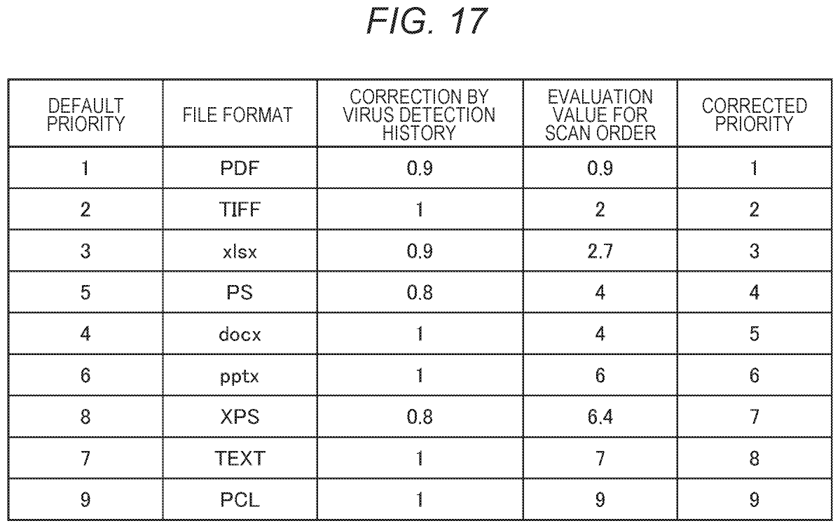

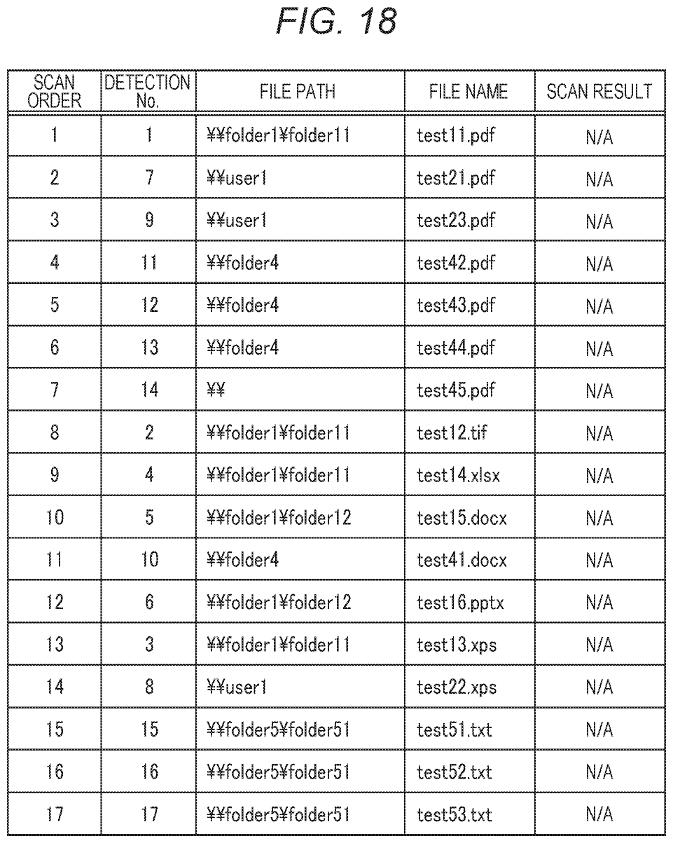

FIG. 17 is a diagram schematically illustrating a priority table corrected on the basis of the number of files of a file format in which a virus has been detected in the second embodiment of the present invention. FIG. 18 is a diagram schematically illustrating a scan table generated by the scan order determining processing (S13 in FIG. 5) on the basis of the corrected priority table illustrated in FIG. 17 in the second embodiment of the present invention.

Referring to FIG. 17, the priority of each file format is corrected so that the higher the number of times a virus is detected, the higher the priority of the file format becomes. Specifically, a coefficient derived from [1−(the number of times a virus has been detected before)×0.1] is entered in the fields of “correction by virus detection history.” In the fields of “evaluation value for scan order,” a value derived from [(default priority)×(correction coefficient based on virus detection history)] is entered. The corrected priority is determined so that the priority increases in ascending order of evaluation values for scan order. Here, the priority of each file format is corrected so that the file formats are listed in the order of “PDF,” “TIFF,” “xlsx,” “PS,” “docx,” “pptx,” “XPS,” “TEXT,” and “PCL.” Note that the corrected priority may be determined is any manner.

As a result, as illustrated in FIG. 18, the higher the priority specified in the corrected priority table a file format of a file is, the earlier the scan order becomes (the smaller the number becomes).

Note that since the configuration and operation other than the above of the image forming apparatus of the present embodiment are similar to those of the first embodiment, description thereof will not be repeated.

According to the present embodiment, the default priority table is corrected depending on the actual state of the image forming apparatus. As a result, since virus scanning can be executed in a more appropriate order, it is possible to further increase the possibility that virus scanning of a file is completed before acceptance of a print instruction for the file stored in a USB memory.

### Third Embodiment

In the present embodiment, an example will be described in which a scan order determined on the basis of a priority table is corrected in the scan order correcting processing (S15 in FIG. 5).

First Example of Scan Order Correction

As a first example of scan order correction, the scan order of a file to which job information is added, among a plurality of files detected from a USB memory, may be corrected (determined) to precede the scan order of a file to which no job information is added.

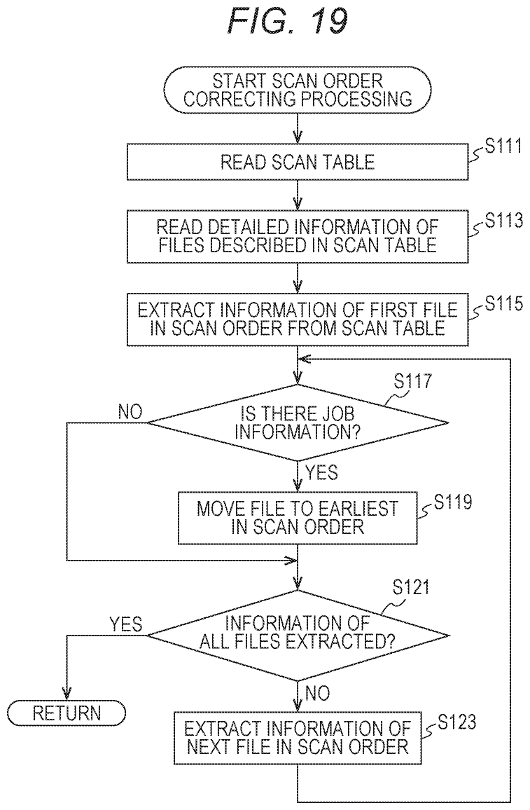

FIG. 19 is a flowchart illustrating a subroutine of the scan order correcting processing (S15 in FIG. 5) in a first example of the third embodiment of the present invention.

Referring to FIG. 19, a CPU 101 reads a scan table in the scan order correcting processing of step S15 in FIG. 5 (S111), and reads detailed information (here, job information) of files listed in the scan table (S113). Next, the CPU 101 extracts information of the first file in the scan order in the scan table (S115) and determines whether job information is added to the extracted file (S117).

Job information is information relating to printing conditions set for a file. There is an advantage that a file can be printed immediately by adding job information to the file in advance.

If it is determined in step S117 that job information is added to the extracted file (YES in S117), the CPU 101 moves the scan order of the extracted file to the top (first place) in the scan table (S119), and then proceeds to processing of step S121.

If it is determined in step S117 that no job information is added to the extracted file (NO in S117), the CPU 101 proceeds to the processing of step S121.

In step S121, the CPU 101 determines whether information of all the files listed in the scan table has been extracted (S121).

If it is determined in step S121 that information of all the files listed in the scan table has not been extracted (NO in S121), the CPU 101 extracts information of the next file in the scan order that has not been extracted (S123), and proceeds to the processing of step S117.

If it is determined in step S121 that information of all the files listed in the scan table has been extracted (YES in S121), the CPU 101 returns from the subroutine.

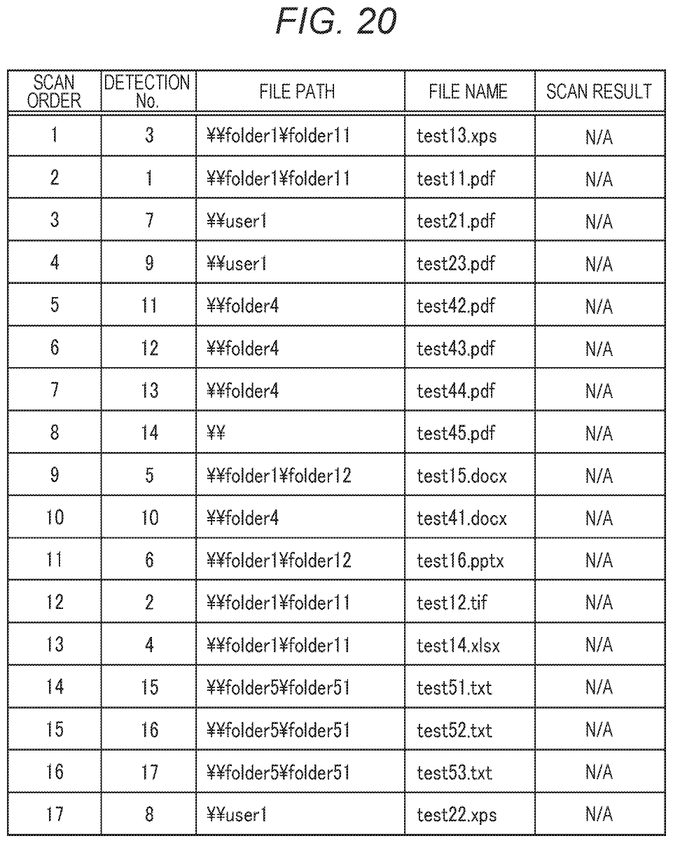

FIG. 20 is a diagram schematically illustrating a scan table corrected in the scan order correcting processing (S15 in FIG. 5) in the first example of the third embodiment of the present invention. Note that the corrected scan table illustrated in FIG. 20 is obtained by correcting the scan table illustrated in FIG. 9.

Referring to FIG. 20, here, it is assumed that job information is added to a file having a name “test13.xps.” The scan order of the file having a name “test13.xps” has been modified from the sixteenth to first place, and the scan order of related files has been lowered along with this modification.

A file added with job information is likely to be selected as a print target file. According to the first example, since a file added with job information is preferentially scanned for viruses, it is possible to further increase the possibility that virus scanning of a file is completed before acceptance of a print instruction for the file stored in a USB memory.

Second Example of Scan Order Correction

As a second example of scan order correction, the scan order of a file updated more recently, among a plurality of files detected from a USB memory, may be corrected (determined) to precede the scan order of a file of the same file format and having a later date of update.

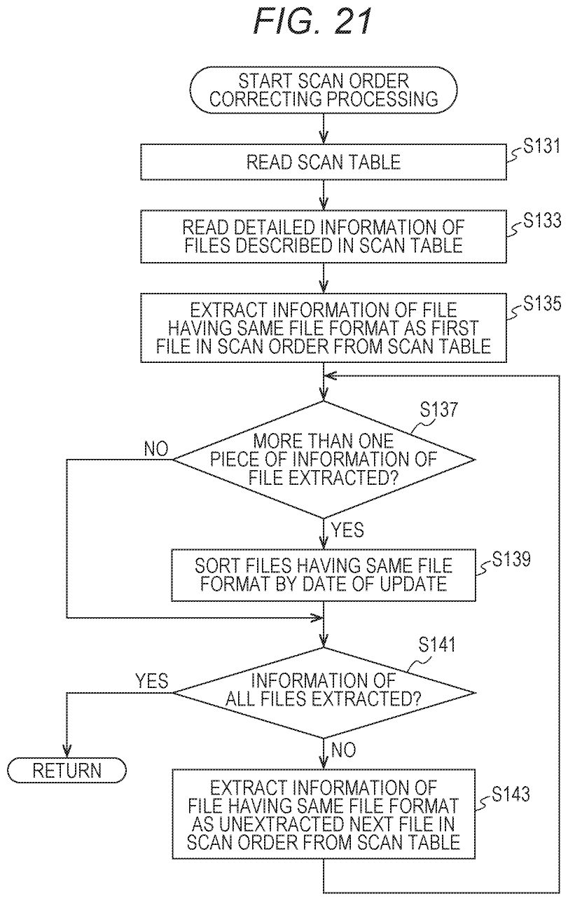

FIG. 21 is a flowchart illustrating a subroutine of the scan order correcting processing (S15 in FIG. 5) in a second example of the third embodiment of the present invention.

Referring to FIG. 21, the CPU 101 reads a scan table in the scan order correcting processing of step S15 in FIG. 5 (S131), and reads detailed information (here, date of update) of files listed in the scan table (S133). Next, the CPU 101 extracts information of a file of the same file format as the file format of the first file in the scan order from the files included in the scan table (S135). Subsequently, the CPU 101 determines whether more than one piece of information of a file has been extracted (S137).

If it is determined in step S137 that not more than one piece of information of a file has been extracted (NO in S137), the CPU 101 proceeds to the processing of step S141 without sorting by date of update.

If it is determined in step S137 that more than one piece of information of files has been extracted (YES in S137), the CPU 101 sorts the files of the same file format by date of update and on the basis of the extracted information of the files (rearrange in the order of date of update from the latest one) (S139). Subsequently, the CPU 101 determines whether information of all the files listed in the scan table has been extracted (S141).

If it is determined in step S141 that information of all the files listed in the scan table has not been extracted (NO in S141), the CPU 101 extracts information of a file of the same file format as the file format of the next file in the scan order that has not been extracted (S143), and proceeds to the processing of step S137.

If it is determined in step S141 that information of all the files listed in the scan table has been extracted (YES in S141), the CPU 101 returns from the subroutine.

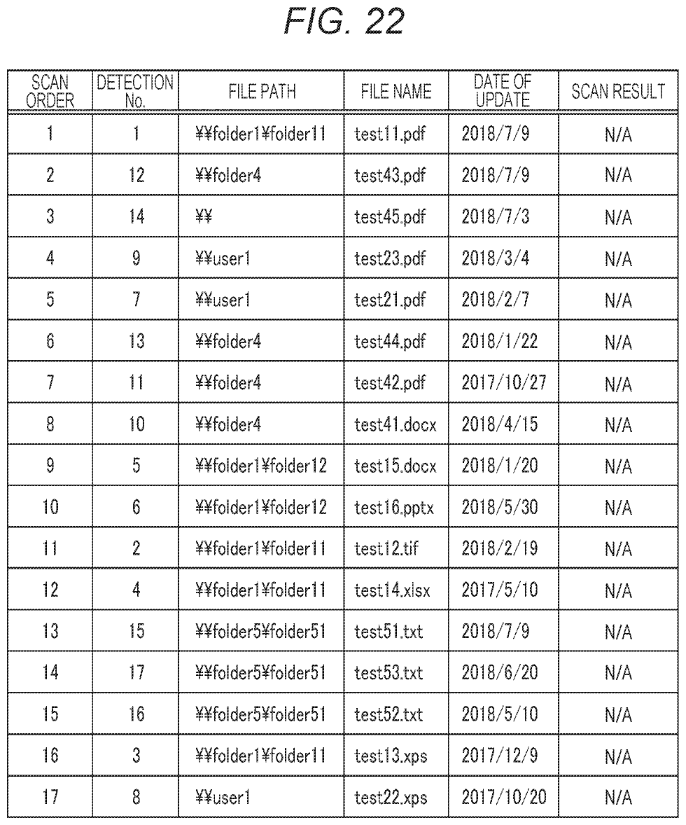

FIG. 22 is a diagram schematically illustrating a scan table corrected in the scan order correcting processing (S15 in FIG. 5) in the second example of the third embodiment of the present invention. Note that the corrected scan table illustrated in FIG. 22 is obtained by correcting the scan table illustrated in FIG. 9. In FIG. 22, the date of update of each file is also indicated for convenience of explanation.

Referring to FIG. 22, seven files of the “PDF” file format that occupied the first to seven places in the scan order in the scan table before correction are each moved as appropriate, among the files of the same file format, so that the more recently a file has been updated, the earlier place in the scan order the file is listed in the corrected scan table. Likewise, two files of the “docx” file format are each moved as appropriate, among the files of the same file format, so that the more recently a file has been updated, the earlier place in the scan order the file is listed in the corrected scan table. Likewise, three files of the “TXT” file format are each moved as appropriate, among the files of the same file format, so that the more recently a file has been updated, the earlier place in the scan order the file is listed in the corrected scan table. Likewise, two files of the “xps” file format are each moved as appropriate, among the files of the same file format, so that the more recently a file has been updated, the earlier place in the scan order the file is listed in the corrected scan table.

A file with a recent date of update is likely to be selected as a print target file. According to the second example, since a file having a recent date of update is preferentially scanned for viruses in a case where there is a plurality of files of the same file format, it is possible to further increase the possibility that virus scanning of a file is completed before acceptance of a print instruction for the file stored in a USB memory.

Third Example of Scan Order Correction

As a third example of scan order correction, the scan order of a file stored in a root folder (folder in the highest layer) of a USB memory out of a plurality of files stored in the USB memory may be corrected (determined) to precede the scan order of a file stored in a place other than the root folder of the USB memory.

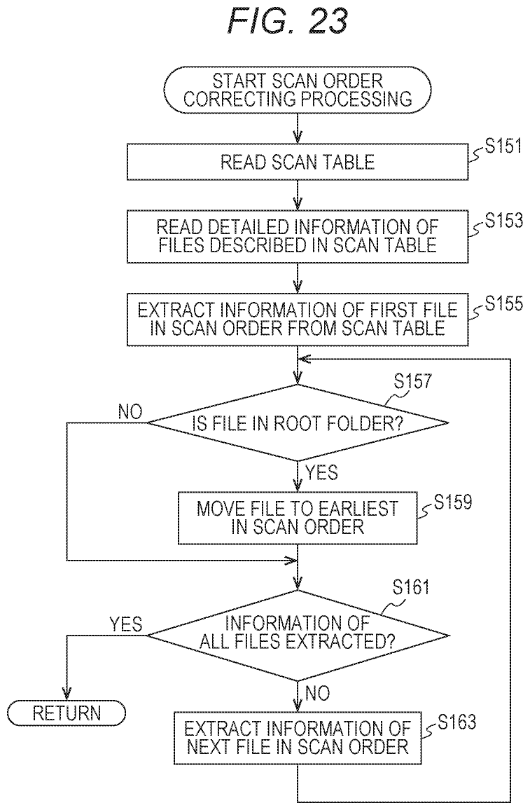

FIG. 23 is a flowchart illustrating a subroutine of the scan order correcting processing (S15 in FIG. 5) in the third example of the third embodiment of the present invention.

Referring to FIG. 23, the CPU 101 reads a scan table in the scan order correcting processing of step S15 in FIG. 5 (S151), and reads detailed information of files (here, storage location of files) listed in the scan table (S153). Next, the CPU 101 extracts information of the first file in the scan order in the scan table (S155) and determines whether the storage location of the extracted file is in the root folder (S157).

If it is determined in step S157 that the storage location of the extracted file is in the root folder (YES in S157), the CPU 101 moves the scan order of the extracted file to the top (first place) in the scan table (S159), and then proceeds to processing of step S161.

If it is determined in step S157 that the storage location of the extracted file is not in the root folder (NO in S157), the CPU 101 proceeds to the processing of step S161.

In step S161, the CPU 101 determines whether information of all the files listed in the scan table has been extracted (S161).

If it is determined in step S161 that information of all the files listed in the scan table has not been extracted (NO in S161), the CPU 101 extracts information of the next file in the scan order that has not been extracted (S163), and proceeds to the processing of step S157.

If it is determined in step S161 that information of all the files listed in the scan table has been extracted (YES in S161), the CPU 101 returns from the subroutine.

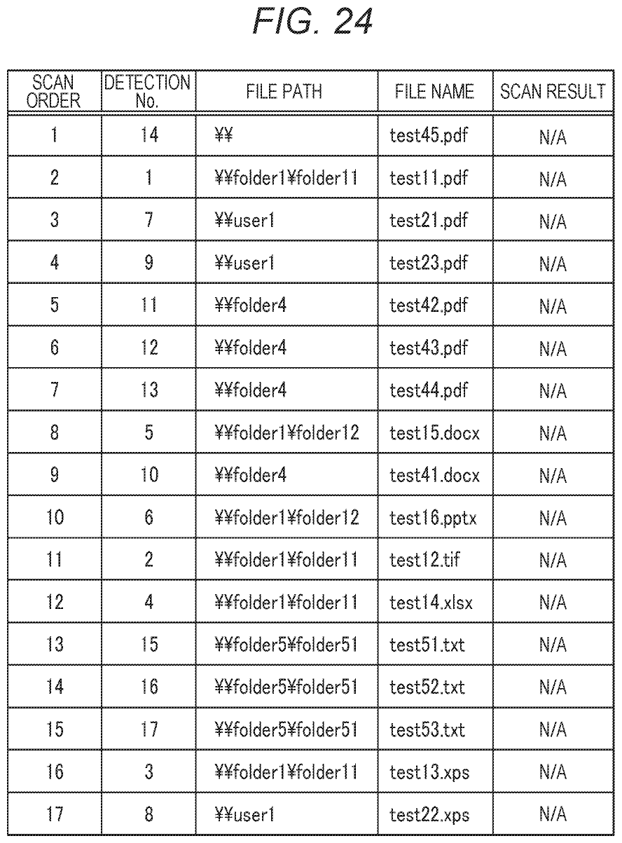

FIG. 24 is a diagram schematically illustrating a scan table corrected in the scan order correcting processing (S15 in FIG. 5) in the third example of the third embodiment of the present invention. Note that the corrected scan table illustrated in FIG. 24 is obtained by correcting the scan table illustrated in FIG. 9.

Referring to FIG. 24, the scan order of the file having a name “test45.pdf” stored in the root folder has been modified from the seventh to first place, and the scan order of related files has been lowered along with this modification.

Since the files in the root folder are storage locations that are not divided into layers, there is a high possibility that those files are not recognized well by the user of the USB memory, and thus there is a high possibility that the files are infected with a virus. According to the third example, since the files stored in the root folder are preferentially scanned for viruses, it is possible to increase the possibility that a vines-infected file is detected promptly.

Fourth Example of Scan Order Correction

As a premise of a fourth example of scan order correction, the image forming apparatus 1 stores, in the fixed storage device 110, information for identifying a user and the name of a specified folder (user folder) specified by the user in association with each other. As the fourth example of scan order correction, the scan order of a file stored in a specified folder out of a plurality of files stored in a USB memory may be corrected (determined) to precede the scan order of a file stored in a place other than the specified folder.

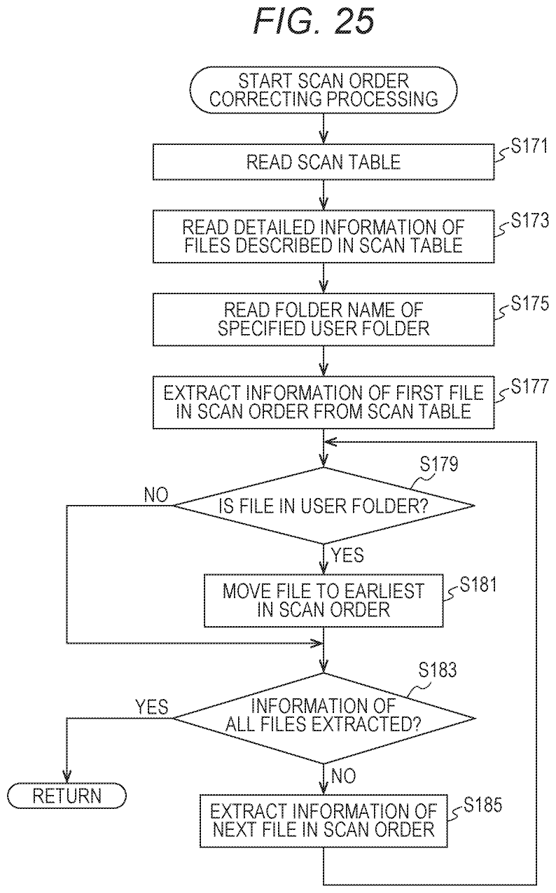

FIG. 25 is a flowchart illustrating a subroutine of the scan order correcting processing (S15 in FIG. 5) in the fourth example of the third embodiment of the present invention.

Referring to FIG. 25, the CPU 101 reads a scan table in the scan order correcting processing of step S15 in FIG. 5 (S171), and reads detailed information of files (here, storage location of files) listed in the scan table (S173).

Subsequently, the CPU 101 reads the name of a user folder specified by the user (S175). Next, the CPU 101 extracts information of the first file in the scan order in the scan table (S177) and determines whether the storage location of the extracted file is in the user folder (S179).

If it is determined in step S179 that the storage location of the extracted file is in the user folder (YES in S179), the CPU 101 moves the scan order of the extracted file to the top (first place) in the scan table (S181), and then proceeds to processing of step S183.

If it is determined in step S179 that the storage location of the extracted file is not in the user folder (NO in S179), the CPU 101 proceeds to the processing of step S183.

In step S183, the CPU 101 determines whether information of all the files listed in the scan table has been extracted (S183).

If it is determined in step S183 that information of all the files listed in the scan table has not been extracted (NO in S183), the CPU 101 extracts information of the next file in the scan order that has not been extracted (S185), and proceeds to the processing of step S179.

If it is determined in step S183 that information of all the files listed in the scan table has been extracted (YES in S183), the CPU 101 returns from the subroutine.

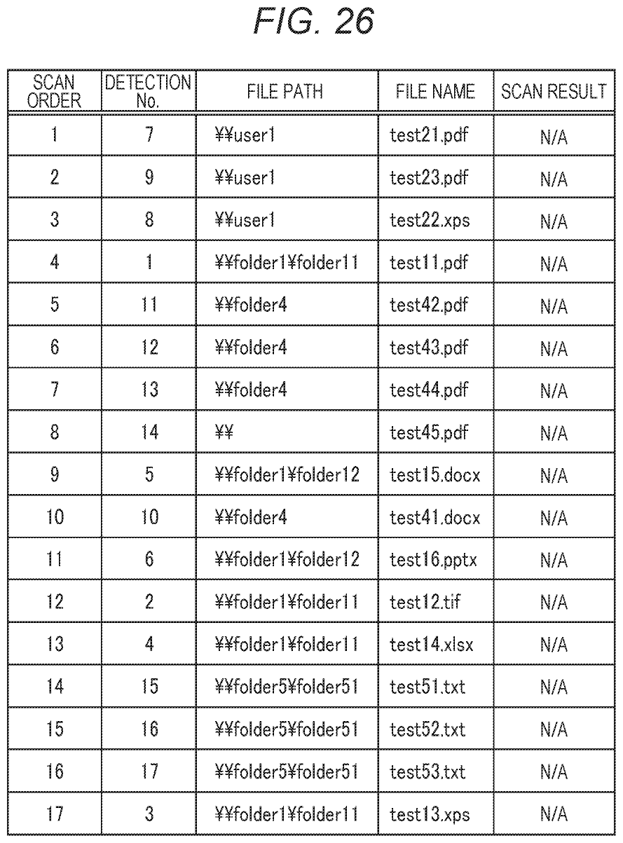

FIG. 26 is a diagram schematically illustrating a scan table corrected in the scan order correcting processing (S15 in FIG. 5) in the fourth example of the third embodiment of the present invention. Note that the corrected scan table illustrated in FIG. 26 is obtained by correcting the scan table illustrated in FIG. 9.

Referring to FIG. 26, it is assumed here that a specified user folder has a folder tome “user1.” The scan order of three files named “test21.pdf,” “test23.pdf,” and “test22.pdf” stored in the user folder has been modified to the first to third places, respectively, and the scan order of related files has been lowered along with this modification.

Since a user folder is a storage location specified by a user, there is a high possibility that a print target file is stored. According to the fourth example, since a file stored in the user folder is preferentially scanned for viruses, it is possible to further increase the possibility that virus seaming of a file is completed before acceptance of a print instruction for the file stored in a USB memory.

Fifth Example of Scan Order Correction

As a premise of a fifth example of scan order correction, it is assumed that the image forming apparatus 1 stores, in the fixed storage device 110, a specified character string which is a character string specified by a user, an administrator, or the like. As the fifth example of scan order correction, the scan order of a file stored in a folder having a name including a specified character string or a file having a name including the specified character string, out of a plurality of files stored in a USB memory, may be corrected (determined) to the earliest.

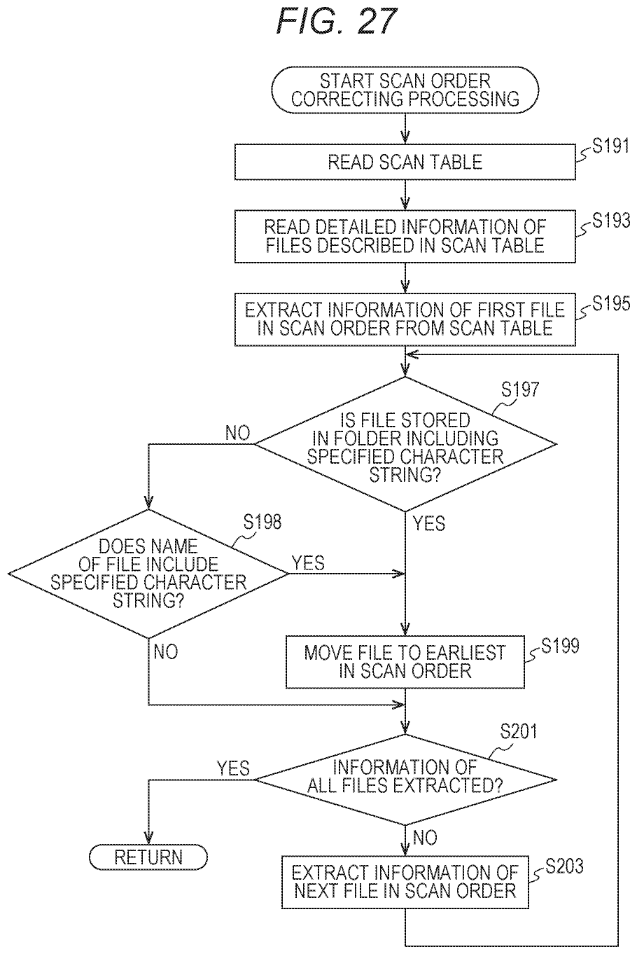

FIG. 27 is a flowchart illustrating a subroutine of the scan order correcting processing (S15 in FIG. 5) in the fifth example of the third embodiment of the present invention.

Referring to FIG. 27, the CPU 101 reads a scan table in the scan order correcting processing of step S15 in FIG. 5 (S191), and reads detailed information of files (here, storage location of files) listed in the scan table (S193).

Next, the CPU 101 extracts information of the first file in the scan order in the scan table (S195) and determines whether the storage location of the extracted file is in a folder including a specified character string (S197).

If it is determined in step S197 that the storage location of the extracted file is not in a folder including the specified character string (NO in S197), the CPU 101 determines whether the name of the extracted file includes the specified character string (S198).

If it is determined in step S198 that the name of the extracted file does not include the specified character string (NO in S198), the CPU 101 proceeds to the processing of step S201.

If it is determined in step S197 that the storage location of the extracted file is in a folder including the specified character string (YES in S197), or it is determined in step S198 that the name of the extracted file includes the specified character string (YES in S198), the CPU 101 moves the scan order of the extracted file to the top (first place) in the scan table (S199), and proceeds to the processing of step S201.

In step S201, the CPU 101 determines whether information of all the files listed in the scan table has been extracted (S201).

If it is determined in step S201 that information of all the files listed in the scan table has not been extracted (NO in S201), the CPU 101 extracts information of the next file in the scan order that has not been extracted (S203), and proceeds to the processing of step S197.

If it is determined in step S201 that information of all the files listed in the scan table has been extracted (YES in S201), the CPU 101 returns from the subroutine.

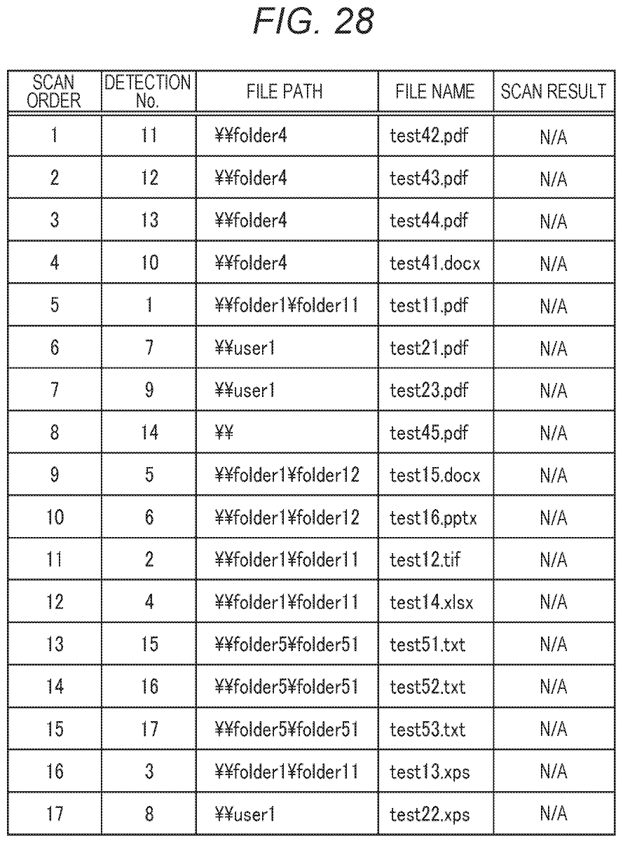

FIG. 28 is a diagram schematically illustrating a scan table corrected in the scan order correcting processing (S15 in FIG. 5) in the fifth example of the third embodiment of the present invention. Note that the corrected scan table illustrated in FIG. 28 is obtained by correcting the scan table illustrated in FIG. 9.

Referring to FIG. 28, it is assumed here that the specified character string is “r4.” The scan order of four files named “test42.pdf,” “test43.pdf,” “test44.pdf,” and “test41.docx” stored in a folder having a name “folder4” including the specified character string has been modified to the first to fourth places, respectively, and the scan order of related files has been lowered along with this modification.

A folder having a name including a specified character string is likely to store a print target file, and a file having a name including the specified character siring is likely to be a print target file. According to the fifth example, since these files are preferentially scanned for viruses, it is possible to further increase the possibility that virus scanning of a file is completed before acceptance of a print instruction for the file stored in a USB memory.

Sixth Example of Scan Order Correction

As a premise of a sixth example of scan order correction, the image forming apparatus 1 stores, in the fixed storage device 110, information for identifying a user and the name of an excluded folder specified for exclusion by the user in association with each other. As the sixth example of scan order correction, a file stored in an excluded folder among a plurality of files stored in a USB memory may be erased from the scan table and excluded from the target of virus scanning.

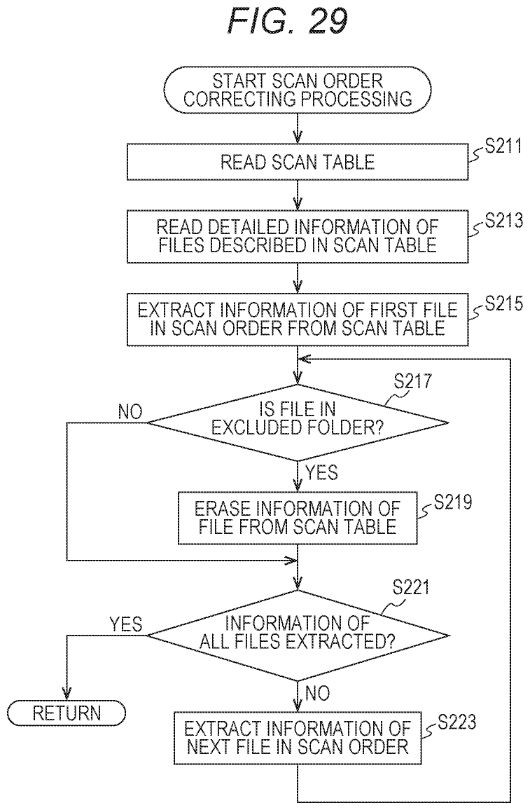

FIG. 29 is a flowchart illustrating a subroutine of the scan order correcting processing (S15 in FIG. 5) in the sixth example of the third embodiment of the present invention.

Referring to FIG. 29, the CPU 101 reads a scan table in the scan order correcting processing of step S15 in FIG. 5 (S211), and reads detailed information of files (here, storage location of files) listed in the scan table (S213). Next, the CPU 101 extracts information of the first file in the scan order in the scan table (S215) and determines whether the storage location of the extracted file is in an excluded folder (S217).

If it is determined in step S217 that the storage location of the extracted file is in the excluded folder (YES in S217), the CPU 101 erases information of the extracted file from the scan table (S219), and the proceeds to processing of step S221.

If it is determined in step S217 that the storage location of the extracted file is not in the excluded folder (NO in S217), the CPU 101 proceeds to the processing of step S221.

In step S221, the CPU 101 determines whether information of all the files listed in the scan table has been extracted (S221).

If it is determined in step S221 that information of all the files listed in the scan table has not been extracted (NO in S221), the CPU 101 extracts information of the next file in the scan order that has not been extracted (S223), and proceeds to the processing of step S217.

If it is determined in step S221 that information of all the files listed in the scan table has been extracted (YES in S221), the CPU 101 returns from the subroutine.

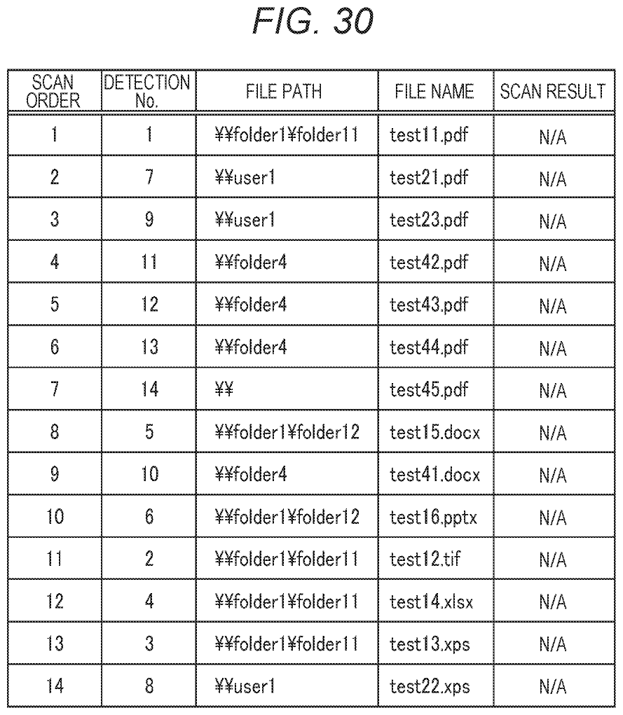

FIG. 30 is a diagram schematically illustrating a scan table corrected in the scan order correcting processing (S15 in FIG. 5) in the sixth example of the third embodiment of the present invention. Note that the corrected scan table illustrated in FIG. 30 is obtained by correcting the scan table illustrated in FIG. 9.

Referring to FIG. 30, it is assumed here that the specified excluded folder has a folder name “folder5.” The information of three files named “test51.txt,” “test52.txt,” and “test53.txt” stored in the excluded folder has been erased from the scan table, and the scan order of related files has been moved up along with this erasure.

Since an excluded folder is a storage location specified by a user, there is a high possibility that a print target file is stored. According to the sixth example, since the files stored in the excluded folder are excluded from scan targets, it is possible to further increase the possibility that virus scanning of a file is completed before acceptance of a print instruction for the file stored in a USB memory.

Seventh Example of Scan Order Correction

As a premise of a seventh example of scan order correction, it is assumed that the image forming apparatus 1 stores, in the fixed storage device 110, an excluded character string which is a character string specified for exclusion by a user, an administrator, or the like. As the seventh example of scan order correction, a file stored in a folder having a name including the excluded character string or a file having a name including the excluded character string, out of a plurality of files stored in a USB memory, may be erased from the scan table and excluded from the target of virus scanning.

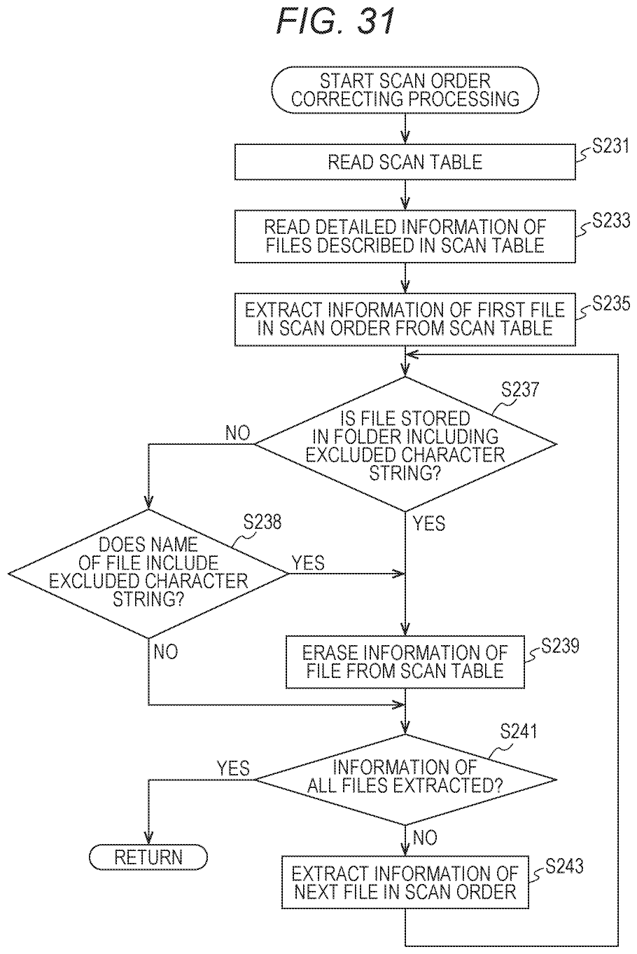

FIG. 31 is a flowchart illustrating a subroutine of the scan order correcting processing (S15 in FIG. 5) in the seventh example of the third embodiment of the present invention.

Referring to FIG. 31, the CPU 101 reads a scan table in the scan order correcting processing of step S15 in FIG. 5 (S231), and reads detailed information of files (here, storage location of files) listed in the scan table (S233). Next, the CPU 101 extracts information of the first file in the scan order in the scan table (S235) and determines whether the storage location of the extracted file is in a folder including the excluded character string (S237).

If it is determined in step S237 that the storage location of the extracted file is not in the folder including the excluded character string (NO in S237), the CPU 101 determines whether the name of the extracted file includes the excluded character string (S238).

If it is determined in step S238 that the name of the extracted file does not include the excluded character string (NO in S238), the CPU 101 proceeds to processing of step S241.

If it is determined in step S237 that storage location of the extracted file is in a folder including the excluded character string (YES in S237), or if it is determined in step S238 that the name of the extracted file includes the excluded character string (YES in S238), the CPU 101 erases information of the extracted file from the scan table (S239), and proceeds to the processing of step S241.

In step S241, the CPU 101 determines whether information of all the files listed in the scan table has been extracted (S241).

If it is determined in step S241 that information of all the files listed in the scan table has not been extracted (NO in S241), the CPU 101 extracts information of the next file in the scan order that has not been extracted (S243), and proceeds to the processing of step S237.

If it is determined in step S241 that information of all the files listed in the scan table has been extracted (YES in S241), the CPU 101 returns from the subroutine.

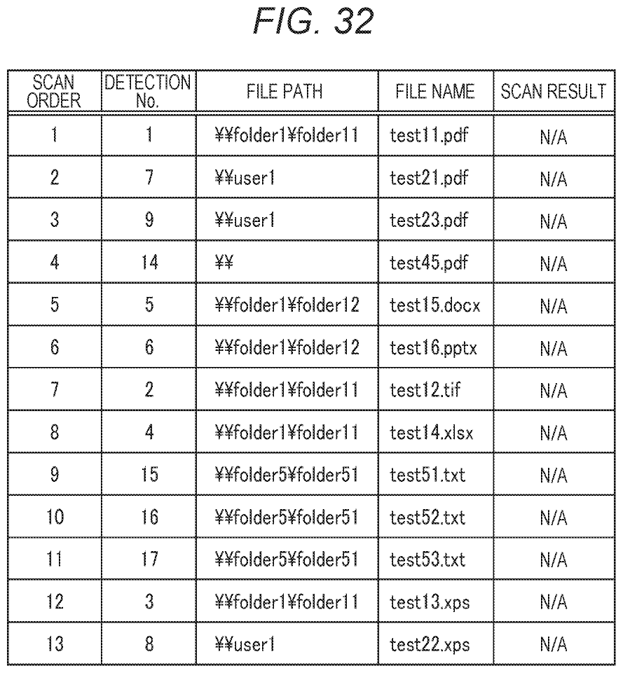

FIG. 32 is a diagram schematically illustrating a scan table corrected in the scan order correcting processing (S15 in FIG. 5) in the seventh example of the third embodiment of the present invention. Note that the corrected scan table illustrated in FIG. 32 is obtained by correcting the scan table illustrated in FIG. 9.

Referring to FIG. 32, it is assumed here that the specified excluded character string is “r4.” Information of four files named “test42.pdf,” “test43.pdf,” “test44.pdf,” and “test41.docx” stored in a folder named “folder4” including the excluded character string is erased from the scan table, and the scan order of related files has been moved up along with this erasure.

A folder having a name including an excluded character string is unlikely to store a print target file, and a file having a name including the excluded character string is unlikely to be a print target file. According to the seventh example, since these files are excluded from scan targets, it is possible to further increase the possibility that virus scanning of a file is completed before acceptance of a print instruction for the file stored in a USB memory.

Note that since the configuration and operation other than the above of the image forming apparatus of the present embodiment are similar to those of the first embodiment, description thereof will not be repeated.

### Fourth Embodiment

In the present embodiment, an example will be explained in which the scan order described in the scan table will be modified in the scan order modifying processing (S33 in FIG. 5) when predetermined operation is accepted in a display 134 after the start of virus scanning.

First Example of Scan Order Modification

As a premise of a first example of scan order modification, a state is assumed in which an image forming apparatus 1 displays folders stored in a USB memory on the display 134. As the first example of scan order modification, when selection of a displayed folder is accepted, the scan order of files in the selected folder may be modified to the earliest order.

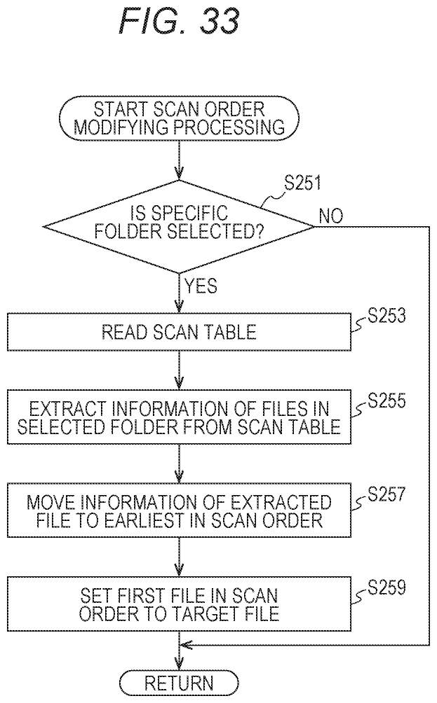

FIG. 33 is a flowchart illustrating a subroutine of the scan order modifying processing (S33 in FIG. 5) in a first example of a fourth embodiment of the present invention.

Referring to FIG. 33, the CPU 101 determines whether a specific folder has been selected in the scan order modifying processing of step S33 of FIG. 5 (S251).

If it is determined in step S251 that no specific folder is selected (NO in S251), the CPU 101 returns from the subroutine.

If it is determined in step S251 that a specific folder has been selected (YES in S251), the CPU 101 reads the scan table (S253), and extracts information of files in the selected folder from the scan table (S255). Next, the CPU 101 moves the scan order of the extracted files to the top (first place) in the scan table (S257), sets the first file in the scan order as a target file of virus scanning (S259), and returns from the subroutine.

Note that in a case where virus scanning of another file is being executed when selection of a displayed folder is accepted, the image forming apparatus 1 may perform virus scanning on the basis of the modified scan table after the virus scanning of the other file is completed, or may perform virus scanning on the basis of the modified scan table by interrupting the virus scanning of the other file.

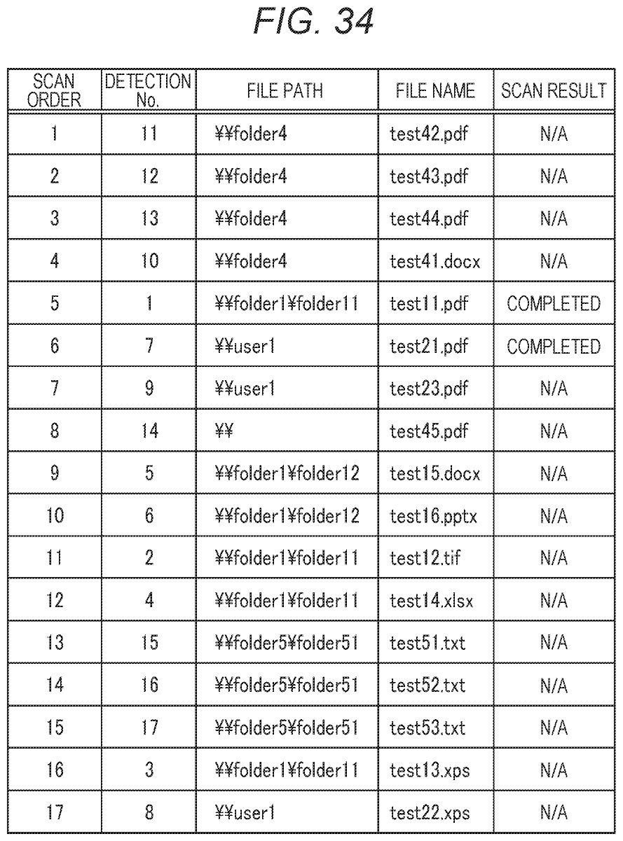

FIG. 34 is a diagram schematically illustrating a scan table after the scan order has been modified in the scan order modifying processing (S33 in FIG. 5) in the first example of the fourth embodiment of the present invention. Note that the modified scan table illustrated in FIG. 34 is obtained by modifying the scan table illustrated in FIG. 9.

Referring to FIG. 34, here, a case is assumed in which the folder “folder4” is selected at the timing when virus scanning of the two files “test11.pdf” and “test21.pdf” that are the earliest in the scan order in the scan table illustrated in FIG. 9 completes. Each of the scan results of the files “test11.pdf” and “test21.pdf” is updated to “completed.”

The scan order of four files named “test42.pdf,” “test43.pdf,” “test44.pdf,” and “test41.docx” stored in the selected folder named “folder4” has been modified to the first to fourth places, respectively, and the scan order of related files has been lowered along with this modification.

A file in the selected folder is likely to be a print target file. According to the first example, since the files in the selected folder are preferentially scanned for viruses, it is possible to further increase the possibility that virus scanning of a file is completed before acceptance of a print instruction for the file stored in a USB memory.

Second Example of Scan Order Modification

As a premise of a second example of scan order modification, a state is assumed in which the image forming apparatus 1 displays files stored in a USB memory on the display 134. As the second example of scan order modification, when selection of a displayed file is accepted, the scan order of the selected file may be modified to the earliest order.

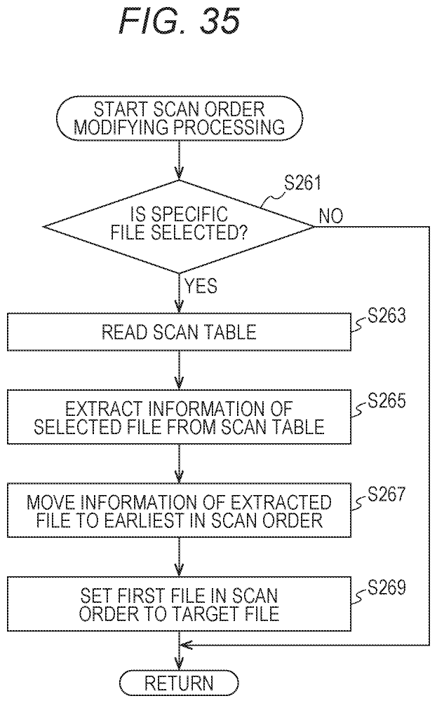

FIG. 35 is a flowchart illustrating a subroutine of the scan order modifying processing (S33 in FIG. 5) in the second example of the fourth embodiment of the present invention.

Referring to FIG. 35, the CPU 101 determines whether a specific file has been selected in the scan order modifying processing of step S33 of FIG. 5 (S261).

If it is determined in step S261 that no specific file is selected (NO in S261), the CPU 101 returns from the subroutine.

If it is determined in step S261 that a specific file has been selected (YES in S261), the CPU 101 reads the scan table (S263), and extracts information of the selected file from the scan table (S265). Next, the CPU 101 moves the scan order of the extracted file to the top (first place) in the scan table (S267), sets the first file in the scan order as a target file of virus scanning (S269), and returns from the subroutine.

Note that in a case where virus scanning of another file is being executed when selection of a displayed file is accepted, the image forming apparatus 1 may perform virus scanning on the basis of the modified scan table after the virus scanning of the other file is completed, or may perform virus scanning on the basis of the modified scan table by interrupting the virus scanning of the other file.

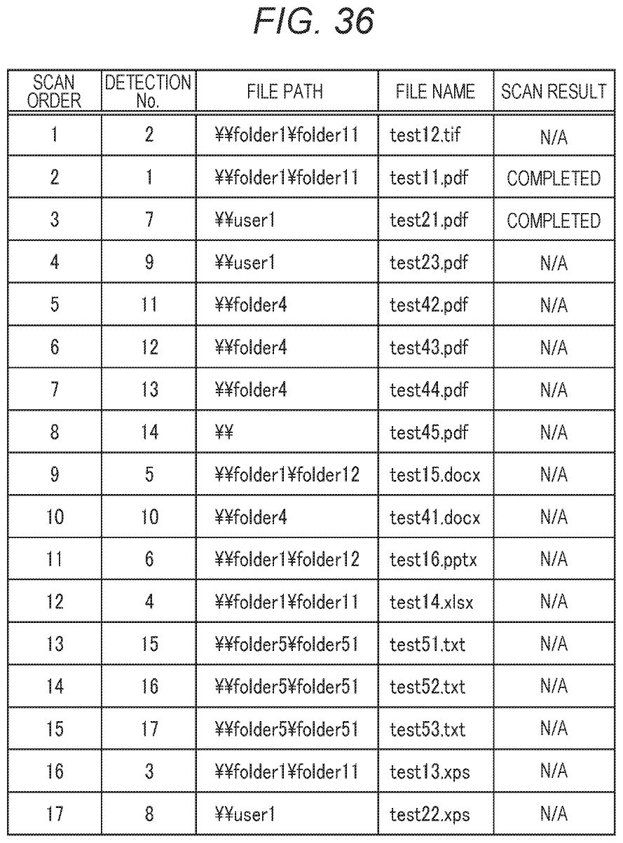

FIG. 36 is a diagram schematically illustrating a scan table after the scan order has been modified in the scan order modifying processing (S33 in FIG. 5) in the second example of the fourth embodiment of the present invention. Note that the modified scan table illustrated in FIG. 36 is obtained by modifying the scan table illustrated in FIG. 9.

Referring to FIG. 36, here, a case is assumed in which a file “test12.tif” is selected at the timing when virus scanning of the two files “test11.pdf” and “test21.pdf” that are the earliest in the scan order in the scan table illustrated in FIG. 9 completes. Each of the scan results of the files “test11.pdf” and “test21.pdf” is updated to “completed.”

The scan order of the selected file “test12.tif” has been modified to the first place, and the scan order of related files has been lowered along with this modification.

The selected file is likely to be a print target file. According to the second example, since the selected file is preferentially scanned for viruses, it is possible to further increase the possibility that virus scanning of a file is completed before acceptance of a print instruction for the file stored in a USB memory.

Note that since the configuration and operation other than the above of the image forming apparatus of the present embodiment are similar to those of the first embodiment, description thereof will not be repeated.

### Fifth Embodiment

In the first embodiment, the operation of the image forming apparatus 1 that stops virus scanning when there is a scan stop flag (S35 in FIG. 5) has been described. In the present embodiment, processing to set a scan stop flag will be described.

First Example of Scan Stop Flag Setting Processing

As a premise of a first example of scan stop flag setting processing, an image forming apparatus 1 accepts selection of an operation mode of the image forming apparatus 1 through the display 134 between an operation mode for printing a file stored in an USB memory and an operation mode for storing data in the USB memory. As the first example of the scan stop flag setting processing, a scan stop flag may be set to stop virus scanning in a case where selection of an operation mode for storing data in the USB memory is accepted during virus scanning.

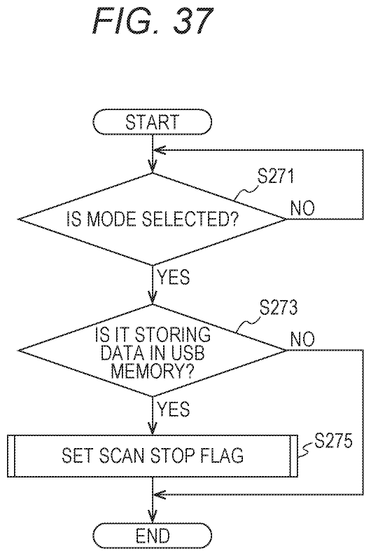

FIG. 37 is a flowchart illustrating the scan stop flag setting processing executed by the image forming apparatus 1 in the first example of the fifth embodiment of the present invention.

Referring to FIG. 37, a CPU 101 determines whether selection of an operation mode of the image forming apparatus 1 has been accepted (S271). The CPU 101 repeats the processing of step S271 until it is determined that selection of an operation mode of the image forming apparatus 1 has been received.

If it is determined in step S271 that the selection of an operation mode of the image forming apparatus 1 has been accepted (YES in S271), the CPU 101 determines whether the selected operation mode is an operation mode for storing data in the USB memory (S273).

If it is determined in step S273 that the selected operation mode is not the operation mode for storing data in the USB memory (NO in S273), the CPU 101 ends the processing without setting a scan stop flag.

If it is determined in step S273 that the selected operation mode is the operation mode for storing data in the USB memory (YES in S273), the CPU 101 sets a scan stop flag (S275) and ends the processing.

A situation assumed when a USE memory is installed to the image forming apparatus 1 is whether a file stored in the USB memory is printed or data is stored in the USE memory. Among these situations, since the image forming apparatus 1 does not access files stored in the USB memory in a situation where data is stored in the USB memory, the possibility that the image forming apparatus 1 becomes infected with a virus is low. According to the first example, since virus scanning is stopped in a situation where data is stored in the USB memory, execution of unnecessary virus scanning can be prevented.

Second Example of Scan Stop Flag Setting Processing

As a premise of a second example of the scan stop flag setting processing, the image forming apparatus 1 displays a maintenance screen that is a screen for performing maintenance of the image forming apparatus 1 in cases such as when predetermined operation is accepted through the display 134. A maintenance screen includes a service mode screen used by a service person of the image forming apparatus 1, an administrator setting screen used by an administrator of the image forming apparatus 1, and the like. As the second example of the scan stop flag setting processing, a scan stop flag may be set to stop virus scanning in a case where the maintenance screen is displayed during virus scanning.

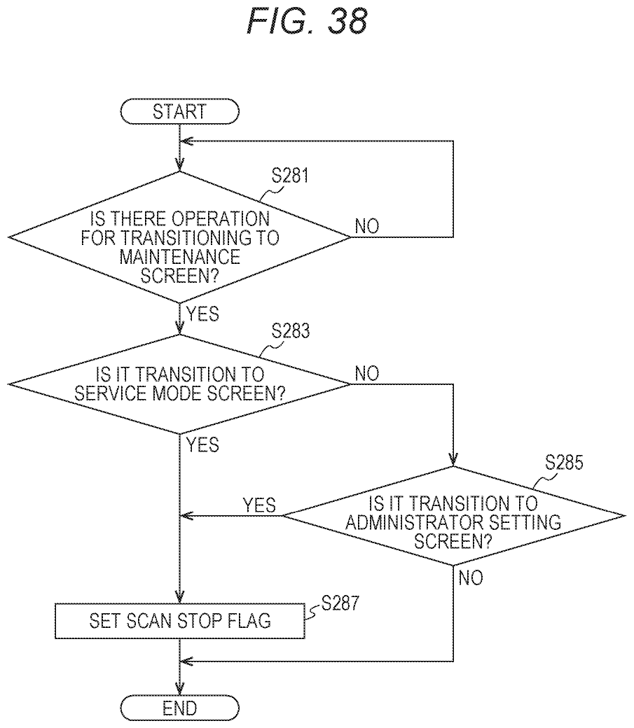

FIG. 38 is a flowchart illustrating the scan stop flag setting processing executed by the image forming apparatus 1 in the second example of the fifth embodiment of the present invention.

Referring to FIG. 38, the CPU 101 determines whether operation for transitioning to the maintenance screen has been accepted (S281). The CPU 101 repeats the processing of step S281 until it is determined that operation for transitioning to the maintenance screen has been accepted.

If it is determined in step S281 that operation for transitioning to the maintenance screen has been accepted (YES in S281), the CPU 101 determines whether the accepted operation is for transition to a service mode screen (S283).

If it is determined in step S283 that the accepted operation is not for transitioning to the service mode screen (NO in S283), the CPU 101 determines whether the accepted operation is for transitioning to an administrator setting screen (S285).

If it is determined in step S285 that the accepted operation is not for transitioning to the administrator setting screen (NO in S285), the CPU 101 ends the processing.

If it is determined in step S283 that the accepted operation is for transitioning to the service mode screen (YES in S283), or if it is determined in step S285 that the accepted operation is for transitioning the administrator setting screen (YES in S285), the CPU 101 sets a scan stop flag (S287) and ends the processing.

In a situation where a service person or an administrator of the image forming apparatus 1 performs maintenance of the image forming apparatus 1, there are cases where the service person or the administrator installs, to the image forming apparatus 1, a USB memory storing necessary data or a program for performing maintenance using the necessary data or the program. In such a situation, since the possibility that files stored in the USB memory are infected with a virus is low, the possibility that the image forming apparatus 1 becomes infected with a virus is low. According to the second example, since virus scanning is stopped when the maintenance screen is displayed, execution of unnecessary virus scanning can be prevented.

Note that since the configuration and operation other than the above of the image forming apparatus of the present embodiment are similar to those of the first embodiment, description thereof will not be repeated.

### Sixth Embodiment

In the present embodiment, a display mode of a file list stored in a USB memory will be described.

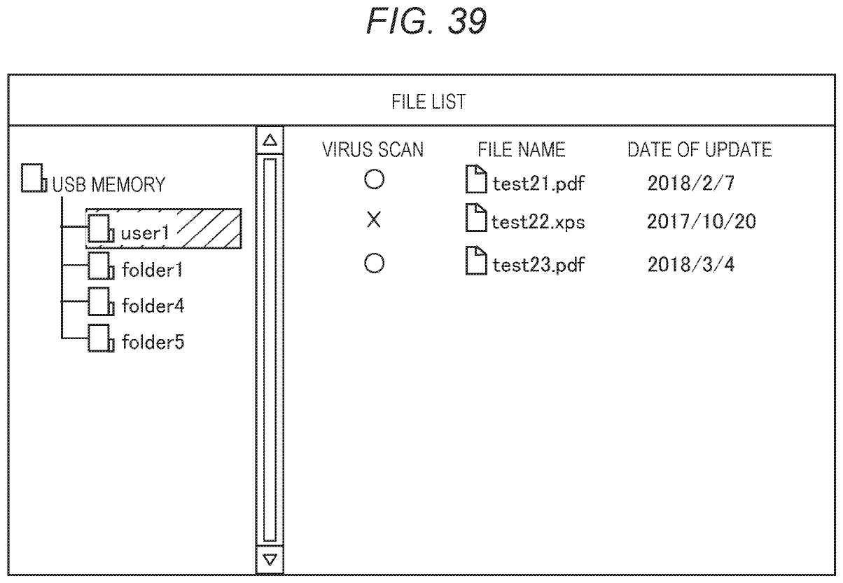

FIG. 39 is a diagram illustrating an exemplary file list stored in a USB memory that is displayed on a display 134 in a sixth embodiment of the present invention.

Referring to FIG. 39, an image forming apparatus 1 displays, on the display 134, a file list that is a list of files stored in the USE memory when accepting predetermined operation through the display 134. Here, the folder “user1” is selected, and information of each of the files “test21.pdf,” “test22.xps,” and “test23.pdf” stored in this folder is displayed.

When the file list is displayed, the names of the files stored in the USE memory may be displayed in different manners in the file list depending on whether virus scanning is completed.

Specifically, the file list includes fields indicating whether virus scanning is completed. Each of the files “test21.pdf” and “test23.pdf” for which virus scanning has been completed is marked with a circle indicating that scanning has been completed, and the file “test22.xps” for which virus scanning has not been completed is marked with an X indicating that scanning has not been completed. How to indicate whether virus scanning has been completed is not limited, and a specific icon may be added to a file for which the virus scanning has been completed, or information of the files may be displayed in different colors depending on whether virus scanning has been completed.

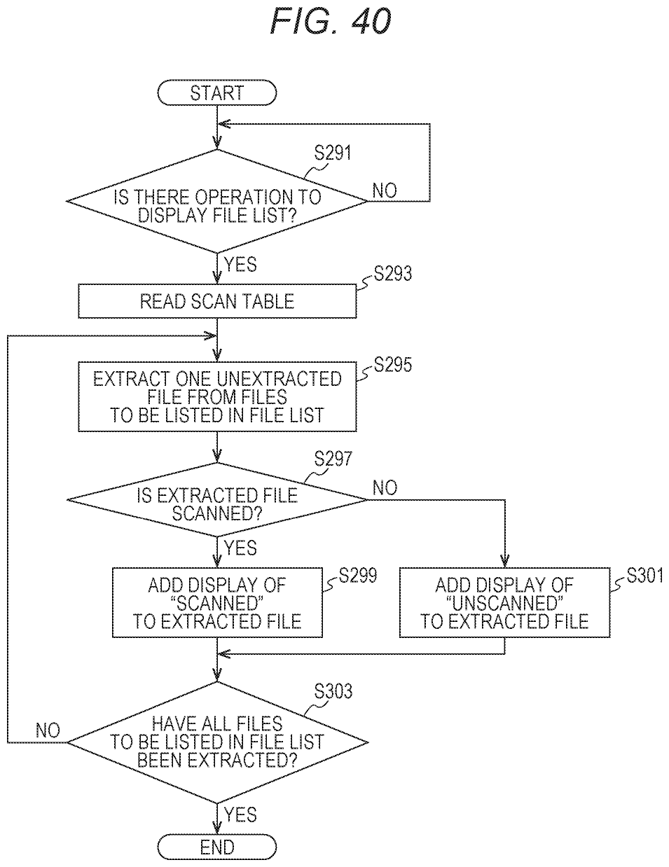

FIG. 40 is a flowchart illustrating display processing a file list executed by the image forming apparatus 1 in the sixth embodiment of the present invention.

Referring to FIG. 40, the CPU 101 determines whether operation to display a file list has been accepted (S291). The CPU 101 repeats the processing of step S291 until it is determined that operation for displaying the file list has been accepted.

If it is determined in step S291 that operation for displaying the file list has been accepted (YES in S291), the CPU 101 reads the scan table (S293), and extracts one file that has not been extracted from files to be listed in the file list (S295). Next, the CPU 101 refers to the scan table to determine whether the extracted file has been scanned for viruses (S297).

If it is determined in step S297 that the extracted file has been scanned for viruses (YES in S297), the CPU 101 adds a display of completion of scanning to the field of the extracted file in the file list (S299), and proceeds to the processing of step S303.

If it is determined in step S297 that the extracted file has not been scanned for viruses (NO in S297), the CPU 101 adds a display of incompletion of scanning to the field of the extracted file in the file list (S301), and proceeds to the processing of step S303.

In step S303, the CPU 101 determines whether all files to be listed in the file list have been extracted (S303).

If it is determined in step S303 that not all the files to be listed in the file list have been extracted (NO in S303), the CPU 101 proceeds to the processing of step S295.

If it is determined in step S303 that all files to be listed in the file list have been extracted (YES in S303), the CPU 101 ends the processing.

Note that since the configuration and operation other than the above of the image forming apparatus of the present embodiment are similar to those of the first embodiment, description thereof will not be repeated.

According to the present embodiment, it is possible to visually confirm the progress of virus scanning of files stored in a USB memory, and thus it is possible to improve convenience for users.

Miscellaneous

An external storage may be an auxiliary storage device such as a hard disk drive (HDD) or a solid state drive (SSD), an SD card, a DVD, or the like other than a USB memory.

The embodiments described above and the examples of the embodiments can be combined as appropriate.

The processing in the above embodiments may be performed by software or by using a hardware circuit. It is also possible to provide a program for executing the processing in the above-described embodiments, and the program may be recorded in a recording medium such as a CD-ROM, a flexible disk, a hard disk, a ROM, a RAM, or a memory card to be provided to a user. The program is executed by a computer such as a CPU. Alternatively, the program may be downloaded to a device via a communication line such as the Internet.

Although embodiments of the present invention have been described and illustrated in detail, it should be considered that the disclosed embodiments are made for purposes of illustration and example only and not limitation in every respect. The scope of the present invention should be interpreted not by the descriptions above but by terms of the appended claims, and it is intended to include all modifications in the meanings equivalent to and within the scope of the claims.

What is claimed is:

1. An image forming apparatus comprising:
a hardware processor that detects multiple files stored in the external storage when an external storage is installed to the image forming apparatus, determines a scan order of each of the multiple files detected by the hardware processor, and scans each of the multiple files for viruses in the scan order, and
an acceptor that accepts a print instruction for a file stored in the external storage,
wherein the hardware processor determines whether it is necessary to execute virus scanning on a print target file before printing depending on whether the hardware processor has completed virus scanning on the print target file, which is the file for which the print instruction has been accepted by the acceptor.

2. The image forming apparatus according to claim 1, further comprising:
a priority storage that stores first priority information indicating a relationship between a file format and priority,
wherein the hardware processor determines the scan order on a basis of the first priority information.

3. The image forming apparatus according to claim 2,
wherein the hardware processor generates second priority information indicating a relationship between a file format and priority by correcting the first priority information, and
the hardware processor determines the scan order on a basis of the second priority information,

4. The image forming apparatus according to claim 3, wherein the hardware processor corrects the first priority information on a basis of the number of files of a file format included in a print history of the image forming apparatus.

5. The image forming apparatus according to claim 3, wherein the hardware processor corrects the first priority information on a basis of the number of files of a file format in which a virus has been detected in a virus scan history of the image forming apparatus.

6. The image forming apparatus according to claim 1, wherein the hardware processor determines the scan order of a file to which job information is added, among the multiple files, to precede the scan order of a file to which no job information is added.

7. The image forming apparatus according to claim 1, wherein the hardware processor determines the scan order of a file having a recent date of update, among the multiple files, to precede the scan order of a file having a later date of update and having a same format as a format of the file having the recent date of update.

8. The image forming apparatus according to claim 1, wherein the hardware processor determines the scan order of a file stored in a root folder of the external storage, among the multiple files, to precede the scan order of a file stored in a location other than the root folder of the external storage.

9. The image forming apparatus according to claim 1, further comprising:
a specified folder storage that stores information for identifying a user and a specified folder specified by the user in association with each other,
wherein the hardware processor determines the scan order of a file stored in the specified folder, among the multiple files, to precede the scan order of a file stored in a location other than the specified folder.

10. The image forming apparatus according to claim 1, further comprising:
a specified character string storage that stores a specified character string that is a character string having been specified,
wherein the hardware processor determines the scan order of a file stored in a folder having a name including the specified character string or a file having a name including the specified character string, among the multiple files, to an earliest order.

11. The image forming apparatus according to claim 1, further comprising:
an excluded folder storage that stores information for identifying a user and an excluded folder specified for exclusion by the user in association with each other,
wherein the hardware processor excludes a file stored in the excluded folder, among the multiple files, from a target of virus scanning by the hardware processor.

12. The image forming apparatus according to claim 1, further comprising:
an excluded character string storage that stores an excluded character string that is a character string having been specified for exclusion,
wherein the hardware processor excludes a file stored in a folder having a name including the excluded character string or a file having a name including the excluded character string, among the multiple files, from a target of virus scanning by the hardware processor.

13. The image forming apparatus according to claim 1, further comprising:
a folder display that displays a folder stored in the external storage and accepts selection of the displayed folder,
wherein the hardware processor modifies the scan order of a file in the selected folder to an earliest order when the folder display accepts selection of the displayed folder.

14. The image forming apparatus according to claim 1, further comprising:
a file display that displays a file stored in the external storage and accepts selection of the displayed file,
wherein the hardware processor modifies the scan order of the selected file to an earliest order when the file display accepts selection of the displayed file.

15. The image forming apparatus according to claim 1, further comprising:
a list display that displays a list of files stored in the external storage,
wherein the list display displays names of the files stored in the external storage in different manners in the list depending on whether virus scanning has been completed by the hardware processor.

16. The image forming apparatus according to claim 1, further comprising:
a mode selection acceptor that accepts selection of an operation mode of the image forming apparatus between an operation mode for printing a file stored in the external storage and an operation mode for storing data in the external storage,
wherein the hardware processor stops virus scanning when the mode selection acceptor accepts selection of the operation mode for storing data in the external storage while the hardware processor is performing virus scanning.

17. The image forming apparatus according to claim 1, further comprising:
a maintenance screen display that displays a maintenance screen that is a screen for performing maintenance of the image forming apparatus,
wherein the hardware processor stops virus scanning When the maintenance screen display displays the maintenance screen while the hardware processor is performing virus scanning.

18. A non-transitory recording medium storing a computer readable control program for an image forming apparatus, the control program causing a computer to perform:
detecting multiple files stored in the external storage when an external storage is installed to the image forming apparatus;
determining a scan order of each of the multiple files detected in the detecting;
scanning each of the multiple files for viruses in the scan order;
accepting a print instruction for a file stored in the external storage; and
determining whether it is necessary to execute virus scanning on a print target file before printing depending on whether virus scanning in the scanning has been completed on the print target file, which is the file for which the print instruction has been accepted in the accepting.
